(19) United States
(12) Patent Application Publication
(10) Pub. No.: US 2006/0244589 A1
(43) Pub. Date: Nov. 2, 2006

(54) METHOD AND SYSTEM FOR AN INSURANCE AUDITOR TO AUDIT A PREMISE ALARM SYSTEM

(76) Inventor: Paul Steven Schranz, Bowen Island (CA)

Correspondence Address: PAUL STEVEN SCHRANZ, BOX G-30 RR1, BOWEN ISLAND, BC, V0N 1G0, CA

(21) Appl. No.: 11/308,194

(22) Filed: Mar. 10, 2006

Related U.S. Application Data
(60) Provisional application No. 60/594,088, filed on Mar. 10, 2005.
(60) Provisional application No. 60/596,025, filed on Aug. 25, 2005.
(60) Provisional application No. 60/597,340, filed on Nov. 25, 2005.

(51) Int. Cl. G08B 1/08

(52) U.S. Cl. 340/539.22

(57) ABSTRACT

There is provided a method for an insurance auditor to derive an insurance premium comprising the steps of obtaining system parameters of a premise alarm system of a premise, and deriving the insurance premium by using the system parameters in a multi-variable function.

### CROSS REFERENCE TO RELATED APPLICATIONS

This application claims domestic priority from the previously filed U.S. Provisional Patent Application Nos. 60/594,088, 60/596,025 and 60/597,340.

### BACKGROUND OF THE INVENTION

1. Field of Invention

The present invention relates to a method and system for an insurance auditor to audit system parameters of a premise alarm system of a premise.

2. Description of Related Art

There are many premise alarm systems and methods that allow monitoring service providers to monitor premise alarm systems. There are also neighborhood premise alarm systems that allow neighbors to be alerted of alarm events within the neighborhood, while simultaneously alerting the monitoring service provider of the alarm event as well.

In United States Patent Application Publication No. 2003/0062997 A1 by Naidoo et al., a system and method for distributed monitoring and remote verification of conditions surrounding an alarm condition in a security system is provided. A security gateway detects alarm conditions at a premise and records video relating to the alarm condition, and transmits an alarm notification and the video across a network to a security system server. The security system server relays information to one or more distributed monitoring clients. An operator at a monitoring client determines whether the alarm condition represents an actual alarm event and activates an appropriate response.

In United States Patent Application No. 2003/0184436 A1 by Seales et al., a security system and method is disclosed that includes a base unit at a monitored premise. When the base unit detects an alarm it establishes radio communications with similar base units or compatible devices at residences within the same neighborhood and transmits voice and other audio information to alert the residents of the activation of the alarm.

These and other conventional systems and methods have the disadvantage of not providing an insurance auditor, for example, without limitation, an insurance provider, an insurance broker or an insurance agent, with access to system parameters of the premise alarm system. This is a disadvantage to a premise insurance policy holder, and to the insurance provider. By way of example only and without limitation, the insurance provider can be a premise insurance provider, a life insurance provider or both.

A conventional business practice of the premise insurance providers is to provide a discount on a premise insurance premium, i.e. homeowners and property insurance, if a premise has a premise alarm system installed. Typically, the premise insurance provider offers an intrusion discount if the premise alarm system can detect intruders or burglars and a fire discount if it can detect fire. A person seeking premise insurance, typically a premise owner or a premise occupant, must provide to the premise insurance provider, the insurance broker or the insurance agent a certificate from a monitoring service provider stating that the premise is protected with a monitored premise alarm system.

The characteristics of the premise alarm system do not influence the discount offered by the premise insurance provider. As long as a minimum level of protection is provided, i.e. a premise alarm system for intrusion and/or fire that is monitored by a monitoring service provider, the respective generic insurance premium discount is offered. This business practice of premise insurance providers has many disadvantages to both the premise insurance provider and to the person seeking premise insurance.

The discount afforded by the monitored premise alarm system is completely offset by the monthly premiums of the monitoring service provider. In fact, it is more expensive to have the discounted premise insurance premium with the premise alarm system monitored by the monitoring service provider than it is to not have the premise alarm system and pay the full premise insurance premium.

If the insurance coverage is the same in both cases, than there is not a great financial advantage to having a monitored premise alarm system. It is a disadvantage of conventional premise alarm systems and methods and conventional business practices of premise insurance providers to not provide a financial advantage in having a premise alarm system installed at a premise.

It is understood that having premise alarm systems installed can significantly aid police in apprehending home intruders and burglars and thereby preventing future break-ins thus saving money for the premise insurance providers and premise insurance customers. It is a disadvantage that there is not a financial incentive to install premise alarm systems so that premise alarm systems become a standard feature for most dwellings which would create an environment that provides police with more indications of home intruding and burglar activity thereby aiding the police in apprehending home intruders and burglars more frequently thus preventing future break-ins.

It is a disadvantage to the premise insurance provider to require the premise alarm system to be monitored by a monitoring service in order for the premise insurance customer to receive an insurance premium discount. The premise insurance provider is in essence transferring part of their insurance premium to the monitoring service provider.

There is a safety benefit in having the premise alarm system since it can notify someone of an emergency event who can then take appropriate action. This can save people from danger, for example, from fire, gas leaks or encounters with home intruders and burglars.

There are many types of premise alarm systems that a person can choose from when protecting their premise. These systems can vary in price from a few hundred dollars to several thousand dollars, and correspondingly vary in ability, reliability and accuracy of reporting alarm events. However, premise insurance providers typically do no differentiate between the different types of alarm systems and provide only a generic insurance premium discount for having a premise alarm system installed at a premise.

The premise insurance provider, and quite often the monitoring service, can not test the operational health of the premise alarm system. Quite often premise alarm systems are installed and verified operationally by a qualified technician, but after that the premise alarm system may later malfunction. This may lead to increased property damage or theft during an emergency event for which the premise insurance provider is liable.

It is a disadvantage of current premise alarm systems and methods not to provide a means for insurance providers to differentiate between the different types of alarm systems.

It is a further disadvantage for premise insurance providers to charge discounted premise insurance premiums to a person who installs a premise alarm system, and to pay for increased property damage or theft because of an emergency event when the premise alarm system was in fact malfunctioning.

The conventional practices of premise insurance providers are a disadvantage to the person seeking premise insurance in not differentiating between the different types of alarm systems. There is no financial incentive to equip the premise with a more able, reliable, accurate and therefore more expensive premise alarm system. The person seeking premise insurance may sacrifice increased safety benefits in order to save on money.

It is a disadvantage to premise insurance providers to not be able to differentiate between the different types of alarm systems. They can not adjust their premise insurance premiums depending upon the system parameters of the premise alarm system which gives an indication of the ability, reliability and accuracy of the premise alarm system.

It is a disadvantage to the premise insurance policy holder who has the premise alarm system installed at their dwelling premise and who also has a life insurance policy from a life insurance provider to not receive a discount on a life insurance premium when the life insurance provider can audit the system parameters of the premise alarm system. The premise alarm system can protect the health and safety of the life insurance policy holder by alarming in case of emergency, for example without limitation, intrusion, fire and gas leak and accordingly the discount on the life insurance premium can be offered.

It is an object of the present invention to overcome these disadvantages by providing a novel method and system for an insurance auditor to remotely audit a premise alarm system.

### SUMMARY OF THE INVENTION

In a first aspect of the present invention a method is provided for an insurance auditor to derive an insurance premium comprising the steps of obtaining system parameters of a premise alarm system of a premise, and deriving the insurance premium by using the system parameters in a multi-variable function.

In a second aspect of the present invention a method is provided for an insurance auditor to audit an insurance policy comprising the steps of obtaining system parameters of a premise alarm system of a premise, and auditing the insurance policy with respect to the system parameters of the premise alarm system.

In a third aspect of the present invention a combination is provided comprising an insurance auditor that audits an insurance policy, a system parameters provider for providing system parameters of a premise alarm system of a premise and a network. The insurance auditor comprises a first data processor, a first data store coupled to the first data processor and a first gateway coupling the first data processor to the network. The insurance auditor also includes a first software program, stored on the first data store and executed on the first data processor. The first software program comprises software instructions for communicating the system parameters from the system parameters provider over the network and software instructions for auditing the insurance policy with respect to the system parameters of the premise alarm system. The system parameters provider comprises a second data processor, a second data store coupled to the second data processor and a second gateway coupling the second data processor to the network. The system parameters provider further includes a second software program, which is stored on the second data store and executes on the second data processor. The second software program comprises software instructions for communicating the system parameters to the insurance auditor over the network.

It is an advantage of the present invention to provide a method and system for an insurance auditor to audit a premise alarm system to obtain system parameters.

The present invention advantageously allows the insurance auditor to determine the type of premise alarm system installed and its corresponding abilities, reliability and accuracy in reporting alarm events. With this information the insurance auditor can calculate the premise or life insurance premium discount according to the type of alarm system installed. This gives incentives to the person seeking premise or life insurance to install better and typically more expensive premise alarm systems for increased protection, which in turn will reduce property damage, theft and death benefiting the insurance auditor and ultimately the insurance customer.

The present invention also allows the insurance auditor to determine the operational status of an installed premise alarm system dynamically in real-time. This allows the insurance auditor to determine if the premise or life insurance premium discount is warranted.

Many advantages of the present invention are further related to the formation of security communities and peer-to-peer premise alarm system monitoring networks. These security communities and peer-to-peer networks are typically, but not always, formed between family, friends and other closely related people.

One advantage is the reduction in false alarms relayed to emergency services, i.e. police and fire department. These security communities and peer-to-peer networks allow family, friends and other closely related people to be notified of alarm events and receive media, i.e. audio or video, representative of the premise generating the alarm. There is no one better than family, friends and closely related people to make a judgment call on whether a person generating an alarm event is an intruder or not. It is much more difficult for a stranger at a monitoring service provider to make this judgment call.

Another advantage related to security communities and the peer-to-peer networks is the elimination of monitoring service fees. As security communities and peer-to-peer networks grow, for example when family, friends and close acquaintances join in, it increasingly becomes statistically likely that at least one person is notified of an alarm event. Under these circumstances the insurance auditor will offer a discount on the premise or life insurance premium while not requiring the premise alarm system to be monitored by a monitoring service provider. The methods and systems of the present invention allow the insurance auditor to dynamically and periodically audit a premise alarm system to determine system parameters of the peer-to-peer network. This provides another financial incentive to insurance customers.

The present invention advantageously provides yet another financial incentive for a person installing a premise alarm system to install a more advanced and expensive premise alarm system that offers increased protection. Again, this is possible because the person will have more financial resources available to spend on the premise alarm system since they will not have to pay monitoring fees in order to obtain the premise insurance premium discount offered by the premise insurance provider.

The present invention advantageously eliminates the essentially inherent transfer of premiums from the insurance provider to the monitoring service provider by eliminating monitoring fees, and without increasing the liability of the insurance provider by the formation of security communities and peer-to-peer networks of premise alarm systems. The insurance provider can offer a discount to the insurance customer according to the system parameters of their premise alarm system, which includes system parameters of any peer-to-peer network, instead of offering a single generic discount for intrusion and for fire. This provides a financial advantage to insurance providers.

The system and method of the present invention provides the ability to record media and alarm event information at peer premise alarm systems other than the premise alarm system generating the event. This ensures that a record of the alarm event is safely stored in a remote location.

### BRIEF DESCRIPTION OF DRAWINGS

The invention will be more readily understood from the following description of preferred embodiments thereof given, by way of example only, with reference to the accompanying drawings, in which:

FIG. 1 is a simplified block diagram of a system for an insurance auditor to audit a premise alarm system according to one embodiment of the present invention;

FIG. 2a is a simplified block diagram of one embodiment of the premise alarm system of FIG. 1;

FIG. 2b is a simplified block diagram of another embodiment of the premise alarm system of FIG. 1;

FIG. 3 is a simplified block diagram of the insurance auditor of FIG. 1;

FIG. 4a is a simplified block diagram of alarm controller software of the premise alarm system of FIG. 1;

FIG. 4b is a simplified block diagram of audit controller software of the insurance auditor of FIG. 1;

FIG. 5a is a simplified flowchart diagram of one aspect of the operation of the audit controller software of FIG. 4b;

FIG. 5b is a simplified flowchart diagram of the operation of the alarm controller software of FIG. 4a in accordance with the operation of the audit controller software in FIG. 5a;

FIG. 6a is a simplified flowchart diagram of one embodiment of performing an insurance policy audit in the operation of the audit controller software in FIG. 5a;

FIG. 6b is a simplified flowchart diagram of another embodiment of performing an insurance policy audit in the operation of the audit controller software in FIG. 5a;

FIG. 7a is a simplified flowchart diagram of another aspect of the operation of the alarm controller software of FIG. 4a;

FIG. 7b is a simplified flowchart diagram of the operation of the audit controller software of FIG. 4b in accordance with the operation of the alarm controller software in FIG. 7a;

FIG. 8a is a simplified block diagram of a system for an insurance auditor to audit a premise alarm system of a peer network of premise alarm systems according to another embodiment of the present invention;

FIG. 8b is a simplified block diagram illustrating peer networks of the embodiment of FIG. 8a;

FIG. 8c is a simplified block diagram illustrating another peer network of the embodiment of FIG. 8a;

FIG. 9a is a simplified flowchart diagram of one aspect of the operation of the alarm controller software of one of the premise alarm systems of FIG. 8;

FIG. 9b is a simplified flowchart diagram of the operation of the alarm controller software of another one of the premise alarm systems of FIG. 8 in accordance with the operation of the alarm controller software in FIG. 9a;

FIG. 10a is a simplified flowchart diagram of the operation of the alarm controller software of one of the premise alarm systems of FIG. 8 having an alarm event;

FIG. 10b is a simplified flowchart diagram of the operation of the alarm controller software of another one of the premise alarm systems of FIG. 8 in accordance with the operation of the alarm controller software in FIG. 10a;

FIG. 11 is a simplified block diagram of a system for a third party to audit a premise alarm system and communicate audit information to an insurance auditor according to another embodiment of the present invention;

FIG. 12 is a simplified block diagram of a system for a monitoring service provider to audit a premise alarm system and communicate audit information to an insurance broker who communicates audit information to a premise insurance provider according to another embodiment of the present invention;

FIG. 13 is a simplified network diagram of a conventional premise alarm system and a central monitoring station;

FIG. 14 is a simplified network diagram of a plurality of the conventional premise alarm systems and the central monitoring station of FIG. 14;

FIG. 15 is a simplified network diagram of a security community service provider and a plurality of conventional premise alarm systems;

FIG. 16 is a block diagram of an application of the security community service provider of FIG. 15; and

FIG. 17 is a simplified flow chart diagram of the operation of the security community service provider of FIG. 15 during an alarm event.

### DESCRIPTION OF PREFERRED EMBODIMENTS

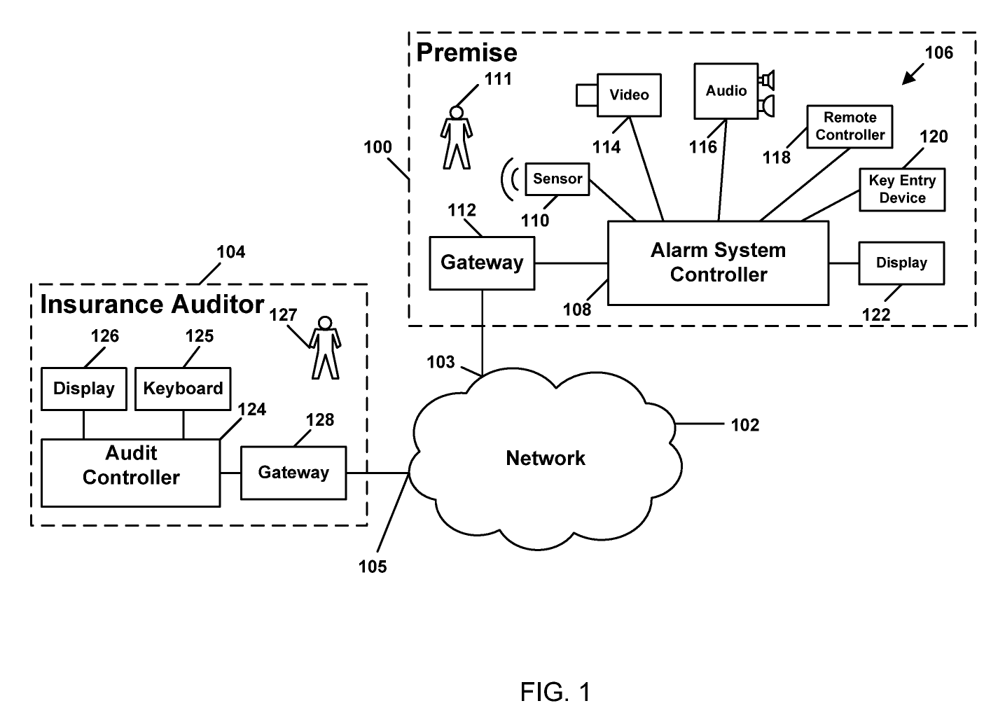

Referring to the drawings and first to FIG. 1, in one embodiment of the present invention there is a premise 100, a network 102 and an insurance auditor 104. The premise 100 has a premise alarm system indicated generally by reference numeral 106 which comprises an alarm system controller 108, at least one sensor 110, a gateway 112, one or more video cameras 114, one or more audio devices 116, a remote controller 118, a key entry device 120 and a display 122 in this example. In other examples the premise alarm system can comprise indoor and outdoor motion lights, indoor and outdoor sirens and indoor water sprinklers. The premise alarm system 106 detects alarm events in and around the premise 100, such as intrusion, fire or gas leaks, and raises an alarm by notifying one or more entities, such as people or other premise alarm systems.

The sensor 110 can be any conventional sensor used in burglar and safety type alarm systems, for example, without limitation, a PIR sensor, a glass break sensor, a smoke detector, a gas detector, an infrared sensor, a radar motion sensor, a Hall-effect sensor and a magnetic sensor. The sensors 110 are strategically placed in and around the premise 100.

The gateway 112 couples the alarm system controller 108 to the network 102. The gateway 112 interfaces with the network 102 at network access point 103. In this example the gateway 112 comprises a modem device and is described in more detail below. In other examples the gateway 112 can comprise more than one modem device, and additionally a network switch, a hub and a VPN router.

The video cameras 114 provide conventional video formats in this example. In other examples the video cameras 114 can provide still images. Each of the video cameras 114 provides images representative of the premise 100 or the area surrounding the premise. During an alarm event it is intended that at least some of the images are related to the alarm event. Some of the video cameras may act, but are not required to act, as video sensors and detect motion in order to provide an indication of an alarm event. The video cameras 114 can include in some examples pan and tilt functionality.

The audio devices 116 comprise a microphone and provide one-way audio communications in this example. In other examples the audio devices 116 can further comprise a speaker and provide two-way audio communications. Each of the audio devices 116 provides audio representative of sound in the premise 100 or the area surrounding the premise. During an alarm event it is intended that at least some of the audio is related to the alarm event. Some of the audio devices 116 may act, but are not required to act, as audio sensors to detect sound in order to provide an indication of an alarm event.

The remote controller 118 allows arming and disarming of the premise alarm system 106 in this example, and may provide other command functionality in other examples. The key entry device 120 can be used to arm and disarm the premise alarm system 106 and for entering other types of commands and data. The display 122 can be used for viewing status information and user menus associated with the premise alarm system 106.

The insurance auditor 104 comprises an audit controller 124, a keyboard 125, a display 126 and a gateway 128 in this example. The gateway 128 couples the audit controller 124 to the network 102. The gateway 128 interfaces with the network 102 at network access point 105. In this example the gateway 128 comprises a modem device and is described in more detail below. The insurance auditor 104 is not shown to be within a premise. Although the insurance auditor 104 is typically within a premise, e.g. an office building or a data center, it is not a requirement. For example, a field technician associated with the insurance auditor 104 may perform an audit, which is described in more detail below, while in the field, e.g. within a company vehicle on location at an insurance customer premise.

The network 102 comprises the Internet in this example and the network access points 103 and 105 provide access to the Internet and are typically provided by Internet Service Providers (ISP). There are many kinds of ISPs that provide access to the Internet, for example, and without limitation, Bell operating companies, cable provider companies, wireless data service provider companies and satellite service provider companies, and all those kinds of ISPs are within the scope of the present invention. In other examples the network 102 can comprise a public or private network, a single network or a combination of two or more networks, a homogenous network or a heterogeneous network. The network 102 can comprise physical connection oriented networks such as the PSTN, or IP based networks such as the Internet. The network 102 can comprise wired networks and wireless networks.

The modem devices of the gateways 112 and 128 are of a type of modem device that corresponds to the network access points 103 and 105 respectively, and are typically related to the type of ISP. By way of non-limiting examples only, if the network access point is provided by a traditional Bell operating company (Plain Old Telephone Service via a PSTN network) then the gateway can comprise a dial-up modem or an xDSL modem, if the network access point is provided by a cable network provider then the gateway can comprise a cable modem, if the network access point is provided by a wireless network provider then the gateway can comprise a GPRS modem or a CDMA modem.

In this example the gateway 112 comprises a CDMA modem and gateway 128 comprises an xDSL modem. The network 102 further comprises a wireless network of a CDMA data service provider that couples the CDMA modem to the Internet, and a PSTN network that couples the xDSL modem to the network.

In other examples the gateways 112 and 128 can comprise interfaces to one or more types of networks contained within the network 102. For example, the premise alarm system 106 may access both the PSTN with a conventional dial-up modem and simultaneously access the Internet with an xDSL or cable modem.

With the arrangement of FIG. 1, the premise alarm system 106 and the insurance auditor 104 can exchange information with each other. The information can be exchanged in a substantially real-time manner, in a non-real-time manner or in a store-and-forward manner.

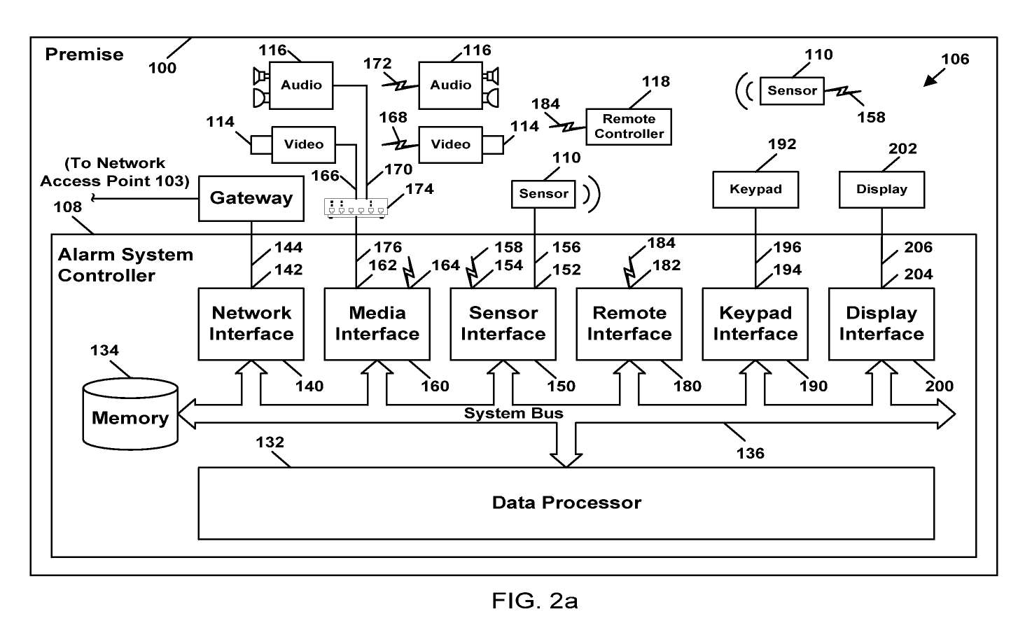

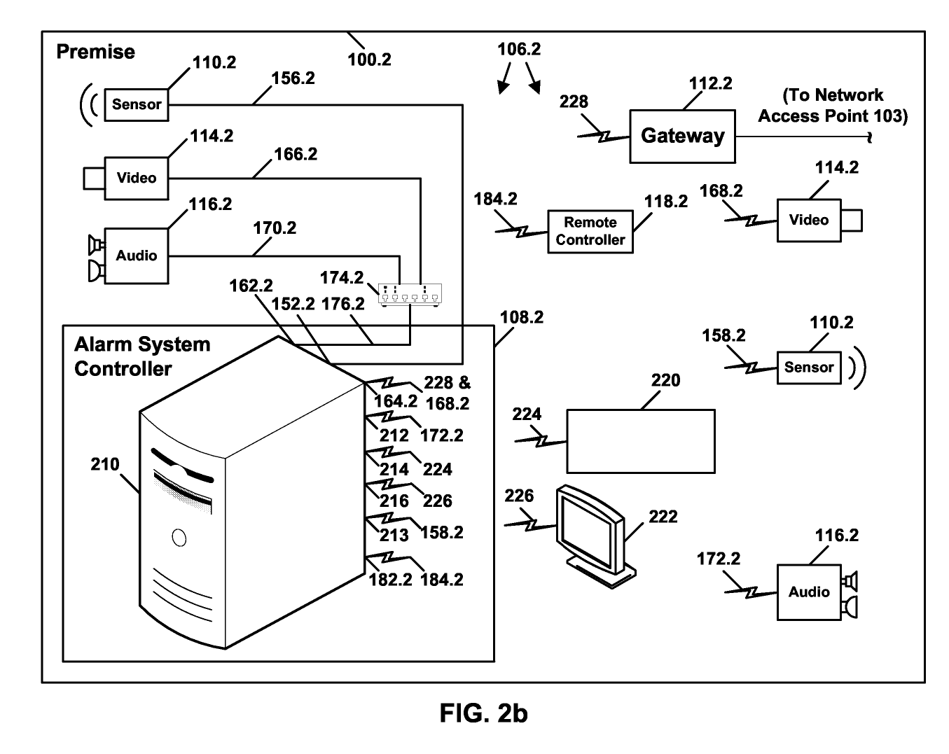

Referring now to FIG. 2a, the premise alarm system 106 is shown in more detail. The alarm controller 108 in this example comprises a data processor 132 and a memory 134. The data processor 132 is a microprocessor in this example, but can comprise, for example, and without limitation, a microcontroller or a digital signal processor in other embodiments. The memory 134 comprises non-volatile memory and volatile memory in this example. The non-volatile memory is an electrically erasable programmable read only memory in this example, but can comprise, without limitation, a read only memory (ROM), a FLASH device or a hard disk in other examples. The volatile memory is a random access memory (RAM) in this example.

The alarm system controller 108 further comprises a network interface 140, a sensor interface 150, a media interface 160, a remote controller interface 180, a keypad interface 190 and a display interface 200 in this example. In other examples the alarm system controller preferably comprises at least the network interface 140 and the sensor interface 150.

The network interface 140 couples the gateway 112 to the data processor 132. The network interface 140 has an I/O port 142, which comprises an Ethernet interface in this example. The gateway 112 is connected to the I/O port 142 by connection 144, which is an Ethernet connection in this example. In other embodiments the I/O port 142 can comprise, for example, without limitation, a wireless Ethernet interface or a Bluetooth interface.

The I/O port 142 of the network interface 140 provides a corresponding interface to the gateway 112. By way of non-limiting example only, if the gateway 112 is a xDSL or a cable modem, which typically provide Ethernet or USB interfaces, then the I/O port 142 can comprise corresponding Ethernet or USB interfaces. If the gateway 112 is a conventional dial-up modem, a GPRS modem or a CDMA modem, which provide conventional serial ports, then the I/O port 142 can comprise a conventional UART interface. In other examples GPRS and CDMA modems can provide Ethernet or PCMCIA type interfaces, and the I/O port 142 would then provide respectively corresponding Ethernet or PCMCIA interfaces.

The sensor interface 150 couples the sensors 110 to the data processor 132. The sensor interface 150 comprises a wired port 152 and a wireless port 154 in this example. In other examples, the sensor interface 150 is not required to have both wired and wireless ports. The wired port 152 comprises a digital CMOS I/O port in this example. The wireless port 154 comprises a Bluetooth interface in this example. In other examples, the wireless port 154 can comprise, for example, without limitation, a wireless Ethernet interface, a Zigabee interface or an ultra-wideband (UWB) interface. One sensor 110 has a wired connection 156 to the wired port 152, and another sensor has a wireless connection 158 to the wireless port 154. The connections 156 and 158 are bi-directional connections for two-way communication in this example, but do not need to be in other examples.

The media interface 160 couples the video cameras 114 and the audio devices 116 to the data processor 132. The media interface 160 comprises a wired port 162 and a wireless port 164 in this example. In other examples, the media interface 160 is not required to have both wired and wireless ports. The wired port 162 comprises an Ethernet interface, and the wireless port 164 comprises a wireless Ethernet interface in this example. In other embodiments there can be more than one wired port 162 having one or more types of wired interfaces, for example, without limitation, a Firewire interface, a USB interface or a serial port interface. In other embodiments, there can be more than one wireless port 164 having one or more types of wireless interfaces, for example, without limitation, a Bluetooth interface.

One video camera 114 has a wired connection 166 and another video camera has a wireless connection 168. One audio device 116 has a wired connection 170 and another audio device has a wireless connection 172. The wired connections 166 and 170 of the video cameras 114 and audio devices 116 respectively are, in this example, Ethernet connections to a network switch 174. The network switch 174 has an Ethernet connection 176 to the wired port 162. In other embodiments, the wired connections can comprise, for example, without limitation, Firewire connections, USB connections or serial port connections terminating in a respective wired port interface.

The wireless connections 168 and 172 of the video cameras 114 and audio devices 116 respectively are wireless Ethernet connections corresponding to the wireless port 164 in this example. In other embodiments the wireless connections 168 and 172 can comprise, for example, Bluetooth connections. In other examples the video cameras 114 can communicate with a wireless Ethernet port and the audio devices can communicate with a Bluetooth port.

The connections 166 and 168 are simplex connections in this example, but are not required to be in other examples. The connections 170 and 172 are also simplex connections in this example, and are also not required to be in other examples.

The remote controller interface 180 comprises a wireless port 182 and couples the remote controller 118 to the data processor 132. The remote controller 118 is connected to the remote controller interface 180 by wireless connection 184. The wireless connection 184 can be any conventional wireless connection including, without limitation, an RFID connection, an infrared connection or a radio frequency connection.

The key entry device 120 of the premise alarm system 106 (see FIG. 1) is a keypad 192 in this example. The keypad interface 190 couples the keypad 192 to the data processor 132. The keypad interface 190 has a port 194 which connects to the keypad 192 by connection 196. The port 194 comprises a corresponding interface to the keypad 192. The connection 196 is a wired connection in this example, but is not required to be in other examples.

The display 122 of the premise alarm system 106 (see FIG. 1) is an LCD display 202 in this example. The display interface 200 couples the LCD display 202 to the data processor 132. The display interface 200 has a port 204 which connects to the LCD display 202 by connection 206. The port 204 comprises a corresponding interface to the LCD display 202. The connection 206 is a wired connection in this example, but is not required to be in other examples.

The data processor 132, the memory 134 and the interfaces 140, 150, 160, 180, 190 and 200 are connected to each other by a system bus 136. It is understood by those in the art that many architectures can be used between the data processor 132, the memory 134 and the interfaces 140, 150, 160, 180, 190 and 200 to achieve an equivalent or similar result to that described above and those architectures are within the scope of the present invention. For example, it is possible in some examples that the network interface 140 and the media interface 160 are replaced by a single communication interface providing either or both wired ports and wireless ports.

Another embodiment of the premise alarm system 106 of FIG. 1 is shown in FIG. 2b, wherein like parts to previous embodiments have like reference numerals with an additional suffix “.2”. The premise alarm system 106.2 comprises an alarm system controller 108.2, a network switch 174.2, a gateway 112.2, one or more video cameras 114.2, one or more audio devices 116.2, one or more sensors 110.2, a remote controller 118.2, a wireless display 222 and a wireless keyboard 220.

The alarm system controller 108.2 comprises a personal computer 210. The personal computer 210 is a conventional personal computer and comprises a microprocessor, a hard disk, dynamic RAM, at least one Ethernet port 162.2, at least one wireless Ethernet port 164.2, at least one Bluetooth port 212, at least one Zigabee port 213, at least one wired port 152.2, an RF port 182.2, a wireless keyboard port 214 and a wireless display port 216 in this example, and can comprise different ports in other examples.

Wireless connection 224 connects the wireless keyboard 220 to the wireless keyboard port 214, and wireless connection 226 connects the wireless display 222 to the wireless display port 216. Wireless connection 184.2 connects the remote controller 118.2 to the RF port 182.2. The gateway 112.2 is connected to the wireless Ethernet port 164.2 by wireless connection 228. Bluetooth connection 172.2 connects one of the audio devices 116.2 to the Bluetooth port 212. Wireless Ethernet connection 168.2 connects one of the video cameras 114.2 to the wireless Ethernet port 164.2. Zigabee connection 158.2 connects one of the sensors 110.2 to the Zigabee port 213. Ethernet connections 166.2 and 170.2 connect one of the video cameras 114.2 and one of the audio devices 116.2 to the network switch 174.2 respectively. The network switch 174.2 is connected to the Ethernet port 162.2 by Ethernet connection 176.2. The wired connection 156.2 connects one of the sensors 110.2 to the wired port 152.2.

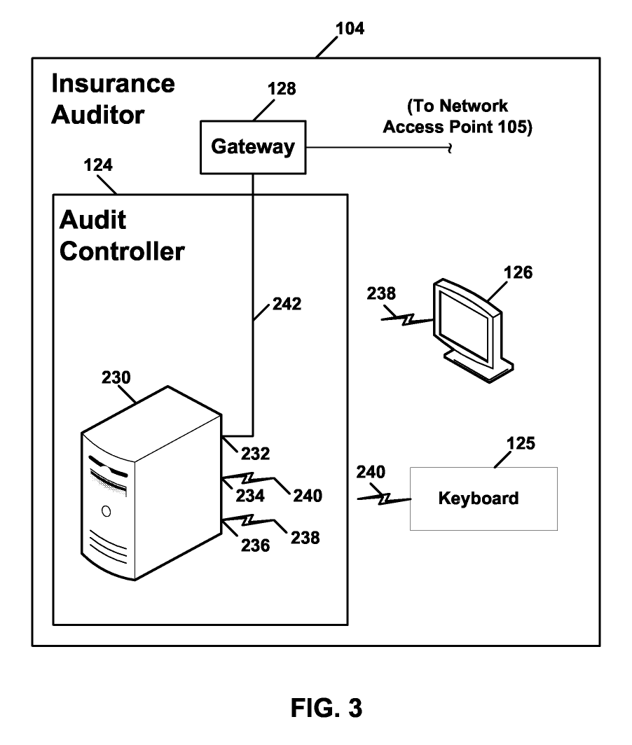

Referring now to FIG. 3, the insurance auditor 104 is shown in more detail. The audit controller 124 comprises a server 230 in this example, and can comprise a personal computer in other examples. The server 230 is a conventional server and comprises a data processor in the form of at least one microprocessor, a hard disk, dynamic RAM, an Ethernet port 232, a wireless keyboard port 234 and a wireless display port 236.

The keyboard 125 is wireless in this example, but is not required to be in other examples, and is connected to the wireless keyboard port 234 by wireless connection 240. The display 126 is wireless in this example, but is not required to be in other examples, and is connected to the wireless display port 236 by wireless connection 238. The gateway 128 is connected to the Ethernet port 232 by wired connection 242. In other examples the gateway 128 can be connected to the server 230 by other types of connections including, without limitation, USB connections and wireless connections.

In other embodiments, the insurance auditor 104 can comprise a laptop computer. This is advantageous for the field technician who needs to perform an audit while on location in the field, e.g. in the company vehicle. In this embodiment, the gateway 128 would comprise, for example, without limitation, a GPRS modem, a CDMA modem or a WiFi modem which would provide, in combination with a wireless CDMA data service provider, the laptop computer with access to the Internet. The laptop computer would communicate with the server 230 in order to obtain customer records, as will be explained in more detail below.

Referring again to FIGS. 1, 2a, 2b and 3, the alarm system controllers 108 and 108.2 have a software program and the audit controller 124 has a software program. The software program of the alarm system controller 108 is stored in the memory 134 and executes on the data processor 132. The software program of the alarm system controller 108.2 is stored on the hard disk drive of the personal computer 210 and executes on the microprocessor of the personal computer 210. These software programs are referred to as the alarm controller software herein. The software program of the audit controller 124 is stored on the hard disk drive of the server 230 and executes on the data processor of the server, and is referred to as the audit controller software herein.

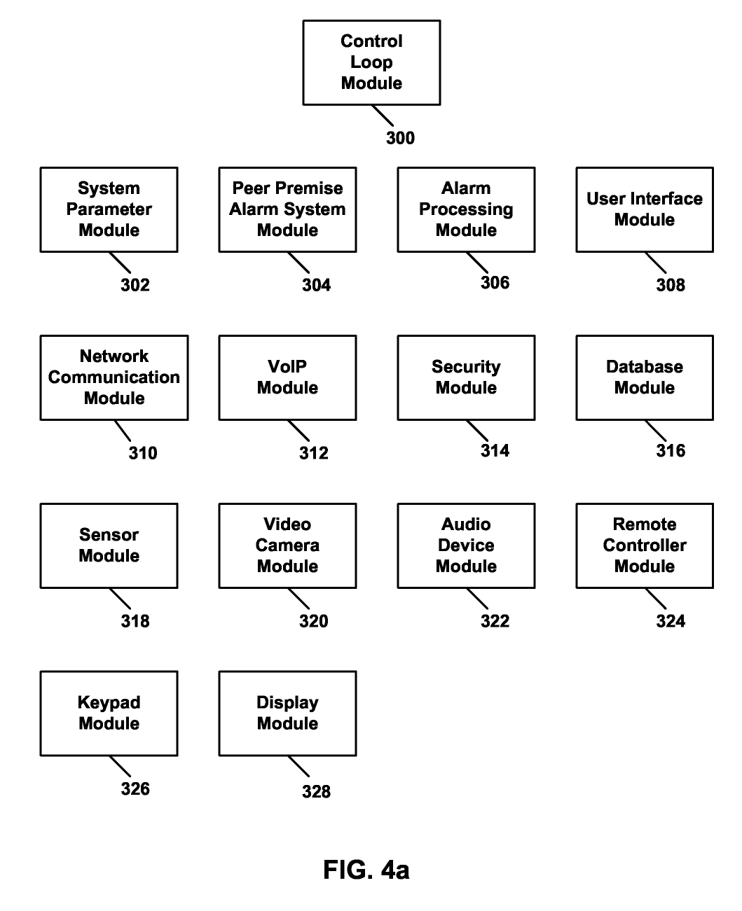

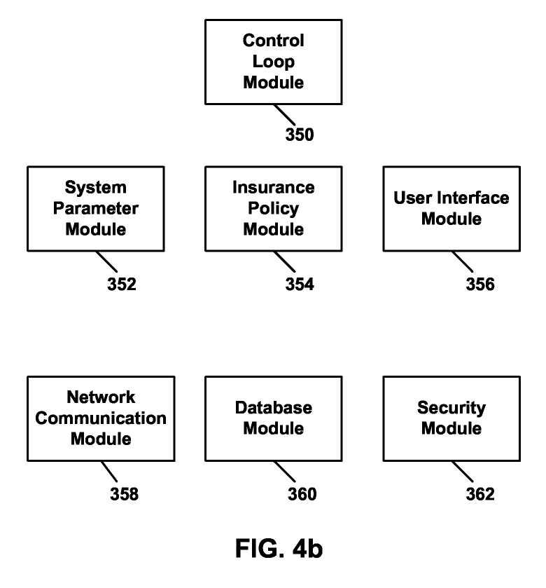

Referring to FIG. 4a, the alarm controller software has a control loop module 300, a system parameter module 302, a peer premise alarm system module 304, an alarm processing module 306, a user interface module 308, a network communication module 310, a Voice/Video over IP module 312, a security module 314, a database module 316, a sensor module 318, a video camera module 320, an audio device module 322, a remote controller module 324, a keypad module 326 and a display module 328. The control loop module 300 includes a main execution loop for the software program of the alarm controllers 108 and 108.2.

The system parameter module 302 includes software instructions related to retrieving, storing and processing system parameters of the premise alarm system 106. The peer premise alarm system module 304 includes software instructions related to forming and maintaining peer networks, which will be described in more detail below. The alarm processing module 306 includes software instructions related to receiving and handling alarm events. The user interface module 308 includes software instructions related to presenting menus and web pages to users and can include, in some examples, a web server such as Apache.

The network communication module 310 includes software instructions related creating and destroying network communication channels over network 102 and logic related to sending and receiving data over those communications channels. The Voice/Video over IP (VoIP) module 312 includes software instructions related to creating, managing and destroying VoIP calls over network 102. The security module 314 includes software instructions related to authenticating insurance auditors 104, other premise alarm systems 106 and other entities in the network 102. The security module 314 also includes software instructions for encrypting and decrypting data. The database module 316 includes software instructions for storing, retrieving and modifying data in a database in the memory 134 of the alarm controller 108 and on the hard disk of the personal computer 210 of the alarm controller 108.2. These databases are referred to as the alarm controller database herein.

The sensor module 318 includes software instructions for communicating with sensors 110. The video camera module 320 includes software instructions related to communicating with the video cameras 114. The audio device module 322 includes software instructions related to communicating with the audio devices 116. The remote controller module 324 includes software instructions for communicating with the remote controller 118.

The keypad module 326 includes software instructions related to communicating with the keypad 192, for example receiving key strokes. The display module 324 includes software instructions related to communicating with the display 122, for example providing user menus.

Referring to FIGS. 2a and 2b, the alarm controllers 108 and 108.2 further comrpise an operating system stored in the memory 134 and the hard disk of the personal computer 210 respectively in this example. The operating system comprises the Linux operating system in this example, and can comprise other operating systems in other examples, such as, without limitation, one of the Microsoft Windows operating systems, UNIX, Mac OS, VxWorks® and QNX®. In other examples the alarm controller 108 does not need to comprise an operation system. The software program of the alarm controllers 108 and 108.2 executes within the operating system. In other examples the operating system can further comprise a Java Virtual Machine (JVM) which executes on top of the operating system and the alarm controller software would execute within the JVM environment.

Referring to FIG. 4b, the audit controller software has a control loop module 350, a system parameter module 352, an insurance premium module 354, a user interface module 356, a network communication module 358, a database module 360 and a security module 362. The control loop module 350 includes a main execution loop for the software program of the audit controller 124.

The system parameter module 352 includes software instructions related to retrieving, storing and processing the system parameters of the premise alarm system 106. The insurance policy module 354 includes software instructions related to auditing insurance policies and calculating insurance premiums. The user interface module 356 includes software instructions related to presenting menus and web pages to users and can include, in some examples, a web server such as Apache. The network communication module 358 includes software instructions related creating and destroying network communication channels over network 102 and software instructions related to sending and receiving data over those communications channels. The database module 360 includes software instructions for storing and retrieving data from a database on the hard disk of the server 230. This database is referred to as the audit controller database herein. The security module 362 includes software instructions related to authenticating premise alarm systems 106 and other entities in the network 102. The security module 362 also includes software instructions for encrypting and decrypting data.

Referring to FIG. 3, the server 230 of the audit controller 124 has an operating system stored on the hard disk of the server 230 in this example. The operating system comprises the Linux operating system in this example, and can comprise other operating systems in other examples, such as, without limitation, one of the Microsoft Windows operating systems, UNIX, Mac OS, VxWorks® and QNX®. The audit controller software executes within the operating system. In other examples the operating system can further comprise a Java Virtual Machine (JVM) which executes on top of the operating system and the audit controller software executes within the JVM environment. The audit controller database is managed by a database program, which is Oracle in this example and can be other database programs in other embodiments, for example, without limitation, MySQL or Microsoft SQL. The database program is also stored on the hard disk of the server 230 and executes on the data processor of the server.

The operation of the software programs of the alarm system controllers 108 and 108.2 and the audit controller 124 are described in more detail below where the operation of the system of the present invention is described.

The system parameters of the premise alarm system 106 include, for example and without limitation, the intrinsic system parameters in the table below.

| Parameter | Definition |
|---|---|
| Timestamp of Last | The date and time of the last audit. |
| Audit | |
| Sensor ID | The identification number of a sensor. |
| Sensor Type | The type of sensor, for example, without limitation, PIR sensor, glass |
| | break sensor, magnetic sensor. |
| Sensor Power | Is the sensor is battery powered or line powered? |
| Sensor Interface | The interface type to the sensor, for example, without limitation, |
| | Bluetooth, digital CMOS, Ethernet, wireless Ethernet, Zigabee. |
| Sensor Status | The current status of the sensor, i.e. communicating with alarm |
| | system controller and operational. |
| Sensor Downtime | The total amount of time the sensor was not operational since the |
| | last audit. |
| Video Camera ID | The identification number of a video camera. |
| Video Camera Type | This indicates the type of video camera, for example, without |
| | limitation, IP camera and CCTV camera. |
| Video Camera Power | This indicates whether the video camera is battery powered or line |
| | powered. |
| Video Camera I/F | This indicates the interface type to the video camera, for example, |
| | without limitation, USB, Ethernet, wireless Ethernet or Bluetooth. |
| Video Camera Status | The current status of the video camera, i.e. communicating with |
| | alarm system controller and operational. |
| Video Camera | The total amount of time the video camera was not operational since |
| Downtime | the last audit. |
| Audio Device ID | The identification number of an audio device. |
| Audio Device Type | The type of audio device, for example, without limitation, |
| | microphone only, microphone and speaker, one-way |
| | communications, two way communications. |
| Audio Device Power | Is the audio device battery powered or line powered? |
| Audio Device I/F | The interface type to the audio device, for example, without |
| | limitation, USB, Ethernet, wireless Ethernet and Bluetooth. |
| Audio Device Status | The current status of the audio device, i.e. communicating with alarm |
| | system controller and operational. |
| Audio Device | The total amount of time the audio device was not operational since |
| Downtime | the last audit. |
| Gateway ID | The identification number of a modem device. |
| Gateway Type | The type of modem device, for example, without limitation, a dial-up |
| | modem, a xDSL modem, a cable modem, a GPRS modem, a CDMA |
| | modem or a WiFI modem. |
| Gateway Status | The current status of the gateway, i.e. communicating with the alarm |
| | system controller and operational. |
| Gateway Downtime | The total amount of time the gateway was not operational since the |
| | last audit. |
| Motion Light ID | Identification number of the motion light. |
| Motion Light | A room ID, premise wall ID or fence ID associated with the motion |
| Location | light. |
| Siren ID | Identification number of the siren. |
| Siren Location | A room ID, premise wall ID or fence ID associated with the siren. |
| Water Sprinkler ID | Identification number of the water sprinkler. |
| Water Sprinkler | A room associated with the water sprinkler. |
| Room | |
| Premise Type | House, Apartment, Townhouse |
| Property Perimeter | Length of perimeter around premise property. |
| Fence ID | Identification number of a fence |
| Fence Type | Type of fence |
| Fence Length | Length of fence |
| Fence Height | Height of fence at lowest portion. |
| Fence Sensor | A sensor ID associated with this fence. |
| Fence Video | An audio device ID associated with the fence. |
| Fence Audio | A video camera ID associated with the fence. |
| Outside Wall ID | Identification number of an outside wall. |
| Outside Wall Door | A door ID associated with the outside wall. |
| Outside Wall | A window ID associated with the outside wall. |
| Window | |
| Outside Wall Sensor | A sensor ID associated with the outside wall. |
| Outside Wall Video | An audio device ID associated with the outside wall. |
| Outside Wall Audio | A video camera ID associated with the outside wall. |
| Door ID | Identification number of a door. |
| Door Location | Is the door a basement outside door, a basement inside door, ground |
| | level outside door, a ground level inside door, an upper storey |
| | outside door or an upper storey inside door? |
| Door Lock | Type of lock on door, for example, without limitation, dead bolt, |
| | locking mechanism. |
| Door Type | Is the door a sliding door, a wood door, a metal door or a glass door? |
| Door Sensor | A sensor ID associated with this window. |
| Door Audio Device | An audio device ID associated with the door. |
| Door Video Camera | A video camera ID associated with the door. |
| Window ID | Identification number of a window. |
| Window Location | Is the window a basement window, a ground level window or an |
| | upper storey window? |
| Window Lock | Type of lock on window, for example, without limitation, auto-lock, |
| | manual lock. |
| Window Type | Is the window a sliding window, a tilt window or other type of |
| | window? |
| Window Sensor | A sensor ID associated with this window. |
| Window Audio | An audio device ID associated with the window. |
| Device | |
| Window Video | A video camera ID associated with the window. |
| Camera | |
| Room ID | Identification number of a room. |
| Room Location | Is the room in the basement, the ground level or an upper storey? |
| Room Windows | A window ID associated with the room. |
| Room Doors | A door ID associated with the room. |
| Room Sensor | A sensor ID associated with the room. |
| Room Audio Device | An audio device ID associated with the room. |
| Room Video Camera | A video camera ID associated with the room. |
| Floor ID | Identification number of the floor. |
| Floor location | Is the floor a basement floor, a ground level floor or an upper storey |
| | floor? |
| Floor Rooms | Room ID associated with the floor. |
| Appliance ID | Identification number of an appliance. |
| Appliance Type | Is the appliance a stove, a fireplace, a furnace, a hot water heater, a |
| | clothes dryer, a clothes washer, a dish washer, a refrigerator or other |
| | type of appliance? |
| Appliance Power | Is the appliance powered by electricity, gas, wood or other type of |
| | power? |
| Appliance Room | A room ID associated with the appliance. |
| Appliance Sensor | A sensor ID associated with the appliance. |
| # of Alarm Events | The number of alarm events during which contact attempts were |
| | made with a contact list. |
| # of Alarm Events | The number of times a person who was contacted about an alarm |
| Acks | event responded to the alarm event. |
| # of Peers | The number of peer premise alarm systems in a peer network with |
| | this premise alarm system. |
| # of Contacts | The number of contacts in the audit controller database. |
| # of Peer Contacts | The total number of contacts in the audit controller databases of the |
| | peer premise alarm systems. |

In the preferred embodiment, each of the sensors 110, video cameras 114 and audio devices 116 has a unique identification number, although it is not required in other examples. This allows the insurance auditor 104 to determine the types of devices installed in the premise alarm system 106 and to track changes in the premise alarm system more accurately during an audit.

Some of the foregoing system parameters are inherently tabulated by the alarm system controller 108, for example, the number of sensors, video cameras and audio devices. Other system parameters need to be tabulated and entered into the alarm controller database by an authorized field technician, for example, the number of doors, windows and rooms, and the mapping of the sensors, video cameras and audio devices to the doors, windows and rooms. It is advantageous to allow a field technician to tabulate these system parameters in order to receive a greater insurance premium discount. The premise or life insurance policy holder would notify the insurance auditor 104, for example in writing, if some of the system parameters that were tabulated by the field technician and entered into the alarm controller database have changed. It is possible that the field technician can perform periodic field audits for these types of parameters.

The operation of the insurance auditor 104 and the premise alarm system 106 are now discussed. Two situations when audits are performed are first described.

In one situation when an insurance customer first installs the premise alarm system 106 at the premise 100 the insurance provider, represented by the insurance auditor 104, must be made aware of the premise alarm system 106 so that a discount on an insurance premium can be obtained. Generally speaking, this can be accomplished in one of two ways, by the insurance auditor 104 contacting and auditing the system parameters of the premise alarm system 106 or the premise alarm system contacting the insurance auditor and providing the system parameters in a self-audit.

In another situation, when the premise 100 already has the premise alarm system 106 installed, a periodic audit may be performed to update the insurance auditor 104 with the system parameters of the premise alarm system 106. Again, generally speaking, this can be accomplished in one of two ways, by the insurance auditor 104 contacting and auditing the system parameters in the premise alarm system 106 or the premise alarm system contacting the insurance auditor and providing the system parameters in a self-audit.

It is understood that a third party can receive the alarm system parameters from the premise alarm system 106 and relay them to the insurance auditor 104 and this situation is considered within the metes and bounds of the present invention. This situation is also described in more detail below.

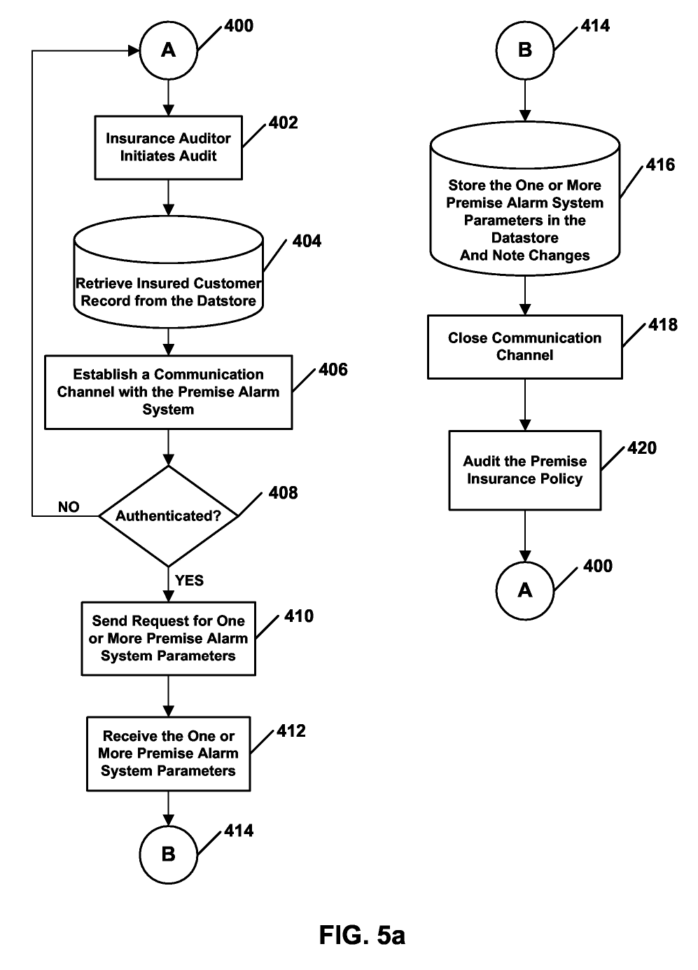

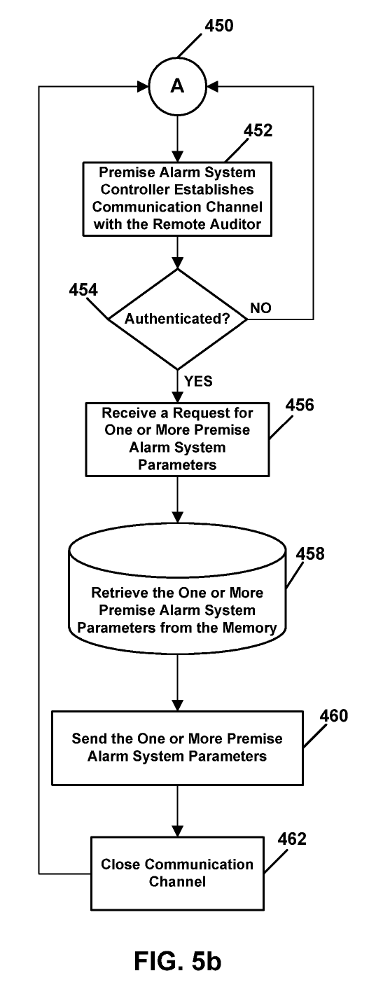

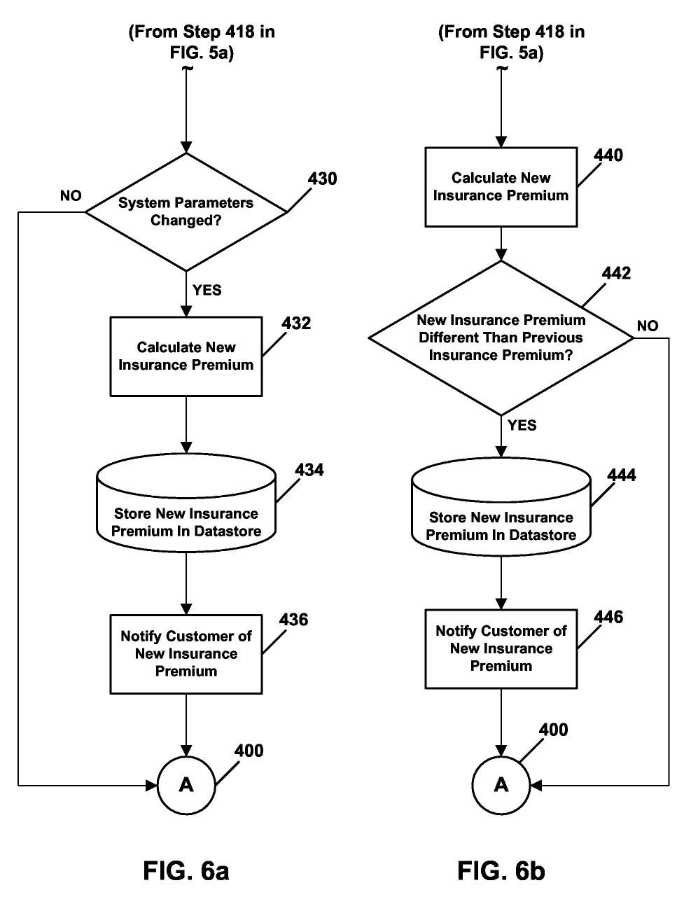

Referring to FIG. 5a, a flowchart diagram is shown illustrating the operation of the insurance auditor 104 remotely auditing the premise alarm system 106. The various steps in FIG. 5a are performed by respective software modules in the audit controller software of FIG. 4b.

The audit controller software is idle in step 400 and in step 402 the audit controller software initiates the operation of auditing system parameters in the premise alarm system 106. A human operator can stimulate the transition from step 400 to step 402, for example if this is the first time the insurance auditor 104 is accessing the system parameters, or the audit controller software can stimulate this transition itself by responding to a scheduled software event when performing scheduled audits. The audit controller software performs housekeeping operations and reserves any resources it may require in step 402, before transitioning to step 404.

The audit controller software retrieves an insurance customer record from the audit controller database in step 404. This record, which may comprise one or more database table records, comprises insurance customer account information and includes a network address of the premise alarm system 106. The network address is parsed from the customer record in step 404, after which the audit controller software transitions to step 406.

The network address of the premise alarm system 106 is used to establish a communication channel with the premise alarm system in step 406. In this example the network address is an IP address on the Internet. The communication channel comprises any conventional means of communicating over the Internet, for example, without limitation, user datagram protocol (UDP) sockets, transmission control protocol (TCP) sockets and security architecture for the Internet protocol (IPsec). When the communication channel is established, the audit controller software transitions to step 408.

The audit controller software may use, but is not required to use, secure communication protocols for the communication channel. For example, the audit controller software can use conventional authentication protocols and conventional cryptographic protocols. In step 408 the audit controller software requests the premise alarm system 106 to authenticate itself by using conventional means of authentication, for example, without limitation, a username and password or a digital certificate issued and verified by a Certificate Authority (CA) and used as part of a public key infrastructure. If the premise alarm system 106 can not authenticate itself the insurance auditor 104 records this event in the audit controller database and notifies an insurance auditor employee, for example by email or in a digital report, to investigate, and then returns to step 400. It is understood by those in the art that steps 406 and 408 can be performed together in other examples.

After the communication channel is established and the premise alarm system 106 is authenticated, the audit controller software uses another protocol on top of the communication channel protocol to send information to and receive information from the premise alarm system 106. The audit controller software sends a request for one or more premise alarm system parameters in step 410 and receives the one or more premise alarm system parameters in step 412.

The system parameters received over the communication channel in step 412 are stored in the audit controller database in step 416 and changes in previously stored system parameters, if any, are also stored in the audit controller database. The communication channel is closed in step 418.

The audit controller software audits the insurance policy in step 420. The audit can be performed in more than one way and involves analyzing the system parameters just received. Two methods are discussed below. In some examples, step 420 can be performed at a later point in time when batch auditing of insurance policies is performed.

Referring to FIG. 6a, a flowchart diagram is shown illustrating one embodiment of the audit controller software performing an audit on the insurance policy in step 420 of FIG. 5a. The audit controller software determines if there is a change in system parameters since a previous audit in step 430. For example, in one situation, if this is the first time the audit controller software has received the system parameters from the premise alarm system 106 then there is a change in system parameters since there were not any system parameters stored in the audit controller database previously. In another situation, the audit controller 124 already has a previous copy of the system parameters stored in the audit controller database and the audit controller software compares the system parameters just received in step 412 of FIG. 5a with the previous system parameters in the audit controller database to determine if there are any changes.

If there is a change in system parameters the audit controller software transitions to step 432 and if there is not a change the audit controller software transitions to step 400. A new insurance premium is derived by calculation in step 432.

A formula used in the calculation is a multivariable function of the system parameters of the premise alarm system 106 in this example. As an example only, the insurance premium can be indirectly proportional to the number of sensors, the number of video cameras, the number of audio devices, the number of peer premise alarm systems in a peer network (to be described below in more detail) and to the total number of contacts who are notified of an alarm event. The new insurance premium is stored in the audit controller database in step 434.

Insurance customers receive a periodic invoice from the insurance provider for premise or life insurance. The periodic invoice has been delivered by mail to the insurance customer and the customer has made payment by check, credit card or electronic funds transfer from an online bank account interface, or the insurance customer has given permission for the insurance provider to receive electronic payment of the invoice by debiting a bank account or charging a credit card of the insurance customer. The metes and bounds of the present invention include adjustment to the periodic invoice based on the new insurance premium calculated above. The insurance policy between the insurance customer and the insurance provider must include a clause for the adjustable insurance premium based on premise alarm system audits.

The automatic billing system of the insurance provider is automatically informed of any new insurance premium. The audit controller software initiates the notification of the insurance customer of the new insurance premium in step 436. The notification can be by way of postal mail or by email for example. After initiating the notification of the customer the audit controller software returns to step 400.

Referring to FIG. 6b, a flowchart diagram is shown illustrating another embodiment of the audit controller software performing an audit on the insurance policy in step 420 of FIG. 5a. A new insurance premium is derived by calculation in step 440. If the new insurance premium is different then the previous insurance premium, if any, then the new insurance premium is stored in step 444. If the new insurance premium is not different then the audit controller software returns to step 400. After storing the new insurance premium in step 444, the audit controller software initiates the notification of the insurance customer in step 446 and then returns to step 400.

In other embodiments the step of auditing 420 can include classifying the premise with the premise alarm system into a category of insurance from a group of categories of insurance. Each category of insurance would have an insurance premium or a discount on an insurance premium associated with it.

In other embodiments the insurance auditor 104 can calculate a discount on an insurance premium instead of calculating an insurance premium directly. The discount is then subtracted from the insurance premium the insurance customer would pay if they did not have the premise alarm system 106. Other methods of auditing the insurance policy based on the system parameters of the premise alarm system and deriving an insurance premium are considered to be within the scope of the present invention.

An example of a formula for calculating an insurance premium discount is illustrated by the equation below. This formula calculates a discount Dₚᵣₑₘᵢₛₑ on a premise insurance premium for a house. The maximum value of each fraction in the equation below is one (1).

There is a maximum discount that can be awarded, which is equal to D_{fl}+D_{f}+D_{owl}+D_{od}+D_{wn}. A discount D_{fl} is given for having a fence around the perimeter of the premise, and the discount is scaled by the ratio of the length of the fence with the length of the perimeter. A discount D_{f} is given for providing surveillance of the fence, and the discount is scaled by a factor related to the nature of the surveillance. A discount D_{owl} is given for providing surveillance of the outside walls of the premise, and the discount is scaled by a factor related to the nature of the surveillance. A discount D_{od} is given for providing surveillance of the outside doors, and the discount is scaled by a factor related to the nature of the surveillance. A discount D_{wn} is given for providing surveillance of the outside windows, and the discount is scaled by a factor related to the surveillance.

$${D}_{premise} = ( \begin{matrix}\begin{matrix}{D}_{fl} \frac{{l}_{f}}{{l}_{p}} + {D}_{f} \frac{{n}_{fs} + {n}_{fv} + {n}_{fa} + {n}_{fm}}{4 {n}_{f}} + \\ {D}_{owl} \frac{{n}_{owls} + {n}_{owlv} + {n}_{owla} + {n}_{owlm}}{4 {n}_{owl}} +\end{matrix} \\ {D}_{od} \frac{{n}_{ods} + {n}_{odv} + {n}_{oda}}{3 {n}_{od}} + {D}_{wn} \frac{{n}_{wns} + {n}_{wnv} + {n}_{wna}}{3 {n}_{wn}}\end{matrix} ) * \frac{2}{ π} {k}_{ c} {tan}^{- 1} ( {k}_{ ppas} {n}_{ ppas} + {k}_{ lc} {n}_{ lc} + {k}_{ pc} {n}_{ pc} )$$

D_{fl} discount for a fence
I_{f} length of fence
Iₚ length of perimeter
D_{f} discount for surveillance of fence
n_{fs} number of sensors associated with fence
n_{fv} number of video cameras associated with fence
n_{fa} number of audio devices associated with fence
n_{fm} number of motion lights associated with fence
n_{f} number of fences
D_{owl} discount for outside wall surveillance
n_{owls} number of sensors associated with outside walls
n_{owlv} number of video cameras associated with outside walls
n_{owla} number of audio devices associated with outside walls
n_{owlm} number of motion lights associated with outside walls
n_{owl} number of outside wals
D_{od} discount for outside door surveillance
n_{ods} number of sensors associated with outside doors
n_{odv} number of video cameras associated with outside doors
n_{ods} number of audio devices associated with outside doors
n_{od} number of outside doors
D_{wn} discount for outside windows surveillance
n_{wns} number of sensors associated with windows
n_{wnv} number of video cameras associated with windows
n_{wna} number of audio devices associated with windows
n_{wn} number of windows
k_{c} constant of proportionality for contacts
kₚₚₐₛ constant of proportionality for peer premise alarm systems
nₚₚₐₛ number of peer premise alarm systems
k_{lc} constant of proportionality for local contacts
n_{lc} number of local contacts
k_{pc} constant of proportionality for peer contacts
n_{pc} number or peer contacts

Another example of a formula for calculating an insurance premium discount is illustrated by the equation below. This formula calculates a discount D_{life} on a life insurance premium. The maximum value of each fraction in the equation below is one (1).

$${D}_{life} = ( {D}_{a} \frac{{n}_{as}}{{n}_{a}} + {D}_{wsp} \frac{{n}_{wsp} + {n}_{rs}}{2 {n}_{r}} ) * \frac{2}{π} {k}_{c} {tan}^{- 1} ( {k}_{lc} {n}_{lc} + {k}_{pc} {n}_{pc} )$$

D_{life} discount for life insurance premium
Dₐ discount for surveillance of appliances
nₐₛ number of appliance sensors
nₐ number of appliances
D_{wsp} discount for water sprinklers
n_{wsp} number of water sprinklers
nᵣₛ number of room sensors
nᵣ number of rooms
k_{c} constant of proportionality for contacts
k_{lc} constant of proportionality for local contacts
n_{lc} number of local contacts
k_{pc} constant of proportionality for peer contacts
n_{pc} number or peer contacts

Now referring to FIG. 5b, a flowchart diagram is shown illustrating the corresponding operation of the alarm controller software of the premise alarm system 106 to the operation of the audit controller software of the insurance auditor 104 in FIG. 5a. The alarm controller software receives a request to establish a communication channel in step 450 and transitions to step 452 where the communication channel is established.

The alarm controller software requests the insurance auditor 104 to authenticate itself by conventional means of authentication in step 454. In most examples authentication would be performed for security reasons, but it is not essential for operation. It is understood that in other examples steps 452 and 454 can be performed together. If the insurance auditor 104 can not authenticate itself the alarm controller software stores a record of this event in the alarm controller database, notifies the insurance customer and returns to step 450. If the insurance auditor 104 can authenticate itself it proceeds to step 456.

A request for one or more system parameters is received over the communication channel from the insurance auditor 104 in step 456. The alarm controller software retrieves the system parameters from the alarm controller database where they are stored. It is understood that the system parameter module 302 in FIG. 4a of the alarm controller software maintains current values of the system parameters in the alarm controller database. It is understood that some of the system parameters may be retrieved in real time from the devices in the premise alarm system 106 illustrated in FIGS. 2a and 2b.

The alarm controller software sends the one or more system parameters to the insurance auditor 104 in step 460 and closes the communication channel in step 462 before returning to step 450.

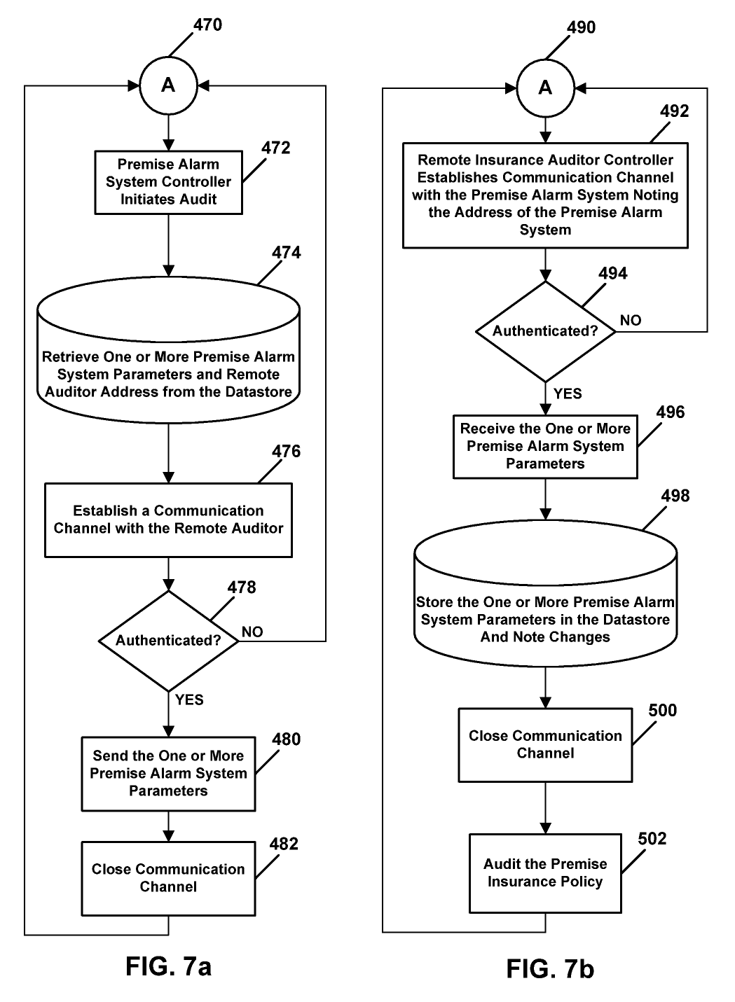

As mentioned above, the premise alarm system 106 may perform the self-audit by contacting the insurance auditor 104 and providing the system parameters as illustrated in the flowchart diagram of FIG. 7a. This situation is similar to the previous situation where the insurance auditor 104 initiated the audit, and many similar steps still apply.

The alarm controller software is idle in step 470 and in step 472 the alarm controller software initiates the self-audit. A human operator can stimulate the transition from step 470 to step 472, for example, if this is the first time the audit is performed, or the alarm controller software can stimulate the transition itself by responding to a scheduled software event when performing scheduled self-audits. The alarm controller software performs housekeeping operations and reserves any resources it may require in step 472, before transitioning to step 474.

In step 474 the alarm controller software retrieves one or more system parameters from the alarm controller database that will be communicated to the insurance auditor 104, and also retrieves the network address of the insurance auditor.

The network address is used to establish a communication channel with the insurance auditor 104 in step 476 in a manner similar to the previous example with the insurance auditor 104 using the network address of the premise alarm system 106 to establish a communication channel. The alarm controller software can request the insurance auditor 104 authenticate itself in step 478, in a manner similar to the previous example where the insurance auditor 104 initiated the audit, to ensure that the communication channel is with the intended insurance auditor. If authentication fails the premise alarm system 106 can log this event in the alarm controller database and terminate the self-audit by returning to step 470. If authentication succeeds the alarm controller software transitions to step 480.

The alarm controller software sends the one or more system parameters to the insurance auditor 104 over the communication channel in step 480. It is possible in some examples for the insurance auditor 104 to request one or more additional system parameters, and the alarm controller software would then send those additional system parameters as well. After all the system parameters have been sent the alarm controller software closes the communication channel in step 482 and returns to step 470.

The flowchart diagram of FIG. 7b illustrates the corresponding operation of the audit controller software of the insurance auditor 104 to the operation of the alarm controller software of the premise alarm system 106 in FIG. 7a. This situation is similar to the previous situation where the insurance auditor 104 initiated the audit, and many similar steps still apply.

The audit controller software receives a request to establish a communication channel in step 490 and transitions to step 492 where the communication channel is established in a manner similar to the previous example where the premise alarm system 106 received a request to establish a communication channel. The audit controller software requests the premise alarm system 106 to authenticate itself in step 494.

The one or more system parameters are received over the communication channel from the premise alarm system 106 in step 496. The audit controller software can request additional system parameters in step 496 as well. The system parameters received from the premise alarm system 106 are stored in the alarm controller database in step 498, and the communication channel is closed in step 500.

The audit controller software audits the insurance policy in step 502 using, for example, the methods of either FIG. 6a or 6b. After the audit of the insurance policy is complete the audit controller software returns to step 490. In some examples, step 502 can be performed at a later point in time when batch auditing of premise insurance policies is performed.

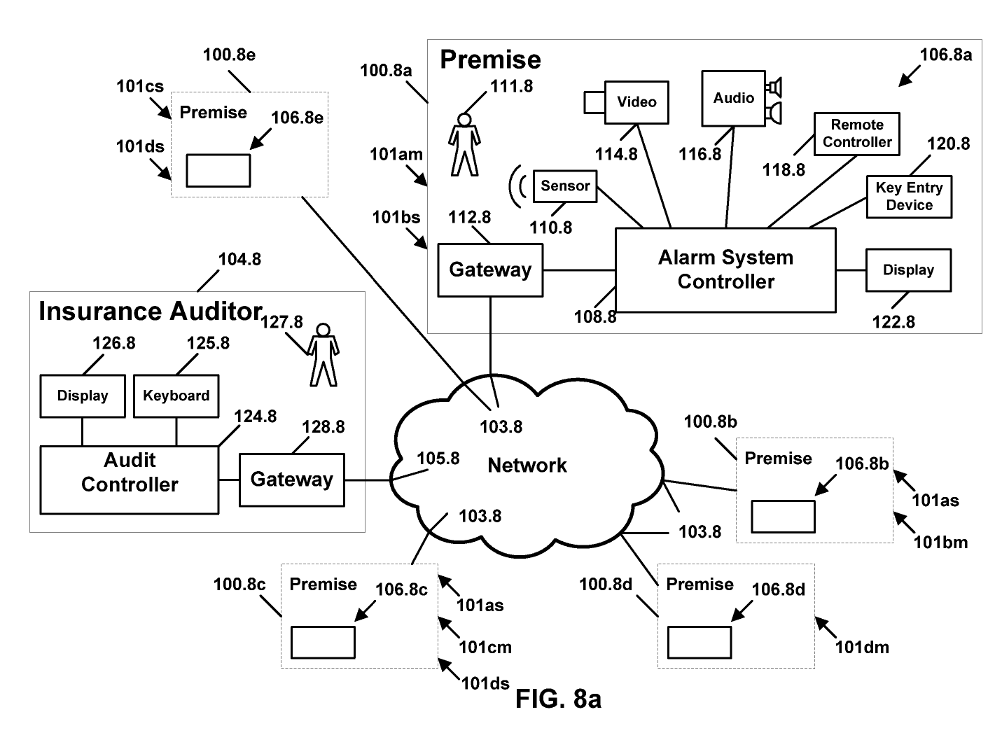

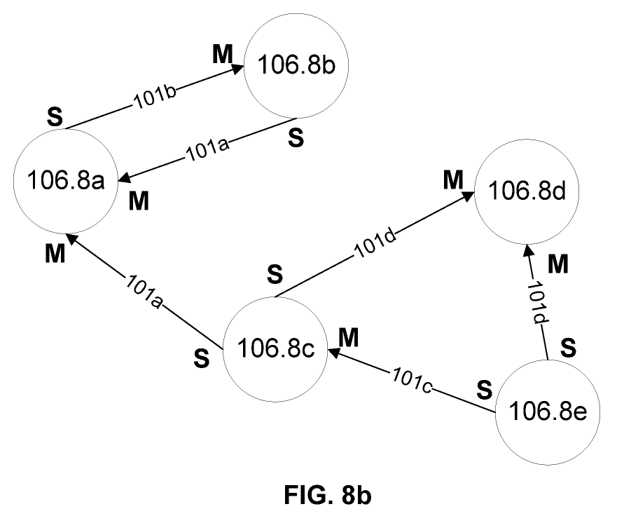

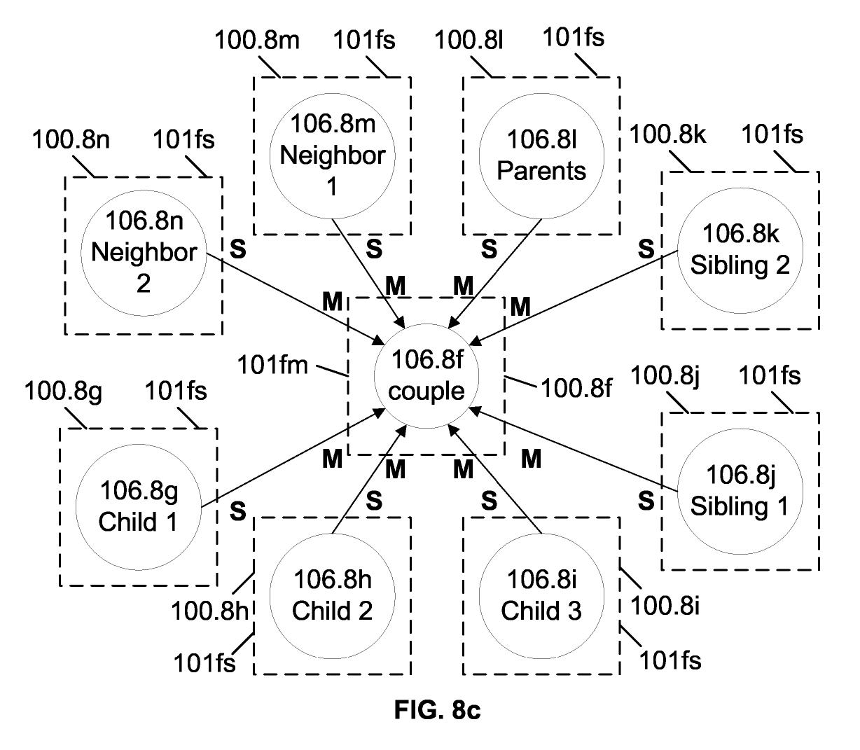

Referring now to FIG. 8a, in another embodiment of the present invention, wherein like parts to previous embodiments have like reference numerals with the additional suffix “.8” and like parts within this embodiment are delineated by additional alphabetical suffixes, there is a system comprising a plurality of premises 100.8, an insurance auditor 104.8 and a network 102.8. Each of the premises 100.8a, b, c, d and e comprise premise alarm systems 106.8a, b, c, d and e respectively that are each similar to the premise alarm system 106 in the previous embodiment.

Each of the premise alarm systems 106.8 can form peer networks. Each premise alarm system 106.8 can belong to a peer network as a master or as a slave, in this embodiment. Each premise alarm system can only belong to one peer network as a master, which is its own peer network, in this embodiment. Each premise alarm system 106.8 can belong to any number of peer networks as a slave, in this embodiment.

Referring to FIGS. 8a and b, a first example of a peer network includes the premise alarm system 106.8a, which has formed peer network generally indicated by root reference numeral 101a, in which it is the master as generally indicated by reference numeral 101am. The premise alarm systems 106.8b and c belong to the peer network 101a as slaves indicated generally by reference numeral 101as.

A second example of a peer network includes the premise alarm system 106.8b, which has formed peer network generally indicated by root reference numeral 101b, in which it is the master as generally indicated by reference numeral 101bm. The premise alarm system 106.8a belongs to the peer network 101b as slave indicated generally by reference numeral 101bs.

A third example of a peer network includes the premise alarm system 106.8c which has formed peer network generally indicated by root reference numeral 101c, in which it is the master as generally indicated by reference numeral 101cm. The premise alarm system 106.8e belongs to the peer network 101c as slave indicated generally by reference numeral 101cs.

A fourth example of a peer network includes the premise alarm system 106.8d, which has formed peer network generally indicated by root reference numeral 101d, in which it is the master as generally indicated by reference numeral 101dm. The premise alarm systems 106.8c and e belong to the peer network 101d as slaves indicated generally by reference numeral 101ds.

The premise alarm systems 106.8 can advantageously communicate alarm and media information with each other during alarm events by forming peer networks. This advantageously allows a large group of contacts, formed by all the contacts within the respective peer network, to be contacted during the alarm events.

Each of the premise alarm systems 106.8 has a list of people to contact during an alarm event which is stored in the alarm controller database. The greater the number of premise alarm systems 106.8 there are in a peer network the greater the number of people that can be contacted in case of an alarm event. The chances of contacting at least one person statistically improve with the greater number of people being contacted. This eliminates the need to require the services of a monitoring service provider, and therefore eliminates the need to pay monitoring fees.

As an example, with reference to FIG. 8c, consider the situation where a couple has three children, two siblings, two neighbors and parents, who all dwell in their own premise 100.8f, g, h, i, j, k, l, m and n and all are married for a total of 18 people. The children, siblings and neighbors each have two children of their own for a total now of 32 people. Each of the premises 100.8f, g, h, i, j, k, l, m and n has premise alarm systems 106.8f, g, h, i, j, k, l, m and n installed which forms a peer network 101f of 9 premise alarm systems. The premise alarm system 106.8f is the master, and the other premise alarm systems 106.8g, h, i, j, k, l, m and n are slaves.

The 32 people above are primary contacts and have authorization to receive media during an alarm event. Each of the 32 people has two friends for an additional 64 people who are secondary contacts and do not have authorization to receive media, but are notified of alarm events and who can themselves contact one of the primary contacts. Therefore, during an alarm event there are a total of 96 people who are contacted and 8 premise alarm systems that can receive media as described in more detail below. It is statistically very probable that a contact will respond to the alarm event. The 96 people are contacted simultaneously, which is possible with the use of Voice/Video over IP technology as will be explained in more detail below.

Another advantage of forming peer networks is the reduction if false alarms which is a serious problem in alarm systems monitored by monitoring service providers. Typically, members in a peer network, such as the peer network 101f, are premise alarm systems of family, friends and close acquaintances, in this case the premise alarm systems 106.8f, g, h, i, j, k, l, m and n. When the members of the peer network 101f are notified of the alarm event they can, depending on their authorization, receive media related to the alarm event, such as video and/or audio. The family, friend and close acquaintance members of the peer network 101f can review the media and determine if it is a false alarm or not, since they would know who has authorization to be at the premise 100.8f and who does not.

A monitoring service provider does not know if a person has authorization by reviewing video and/or audio of the alarm event since they do not know the family, friends or close acquaintances of the premise 100.8f generating the alarm event, unless the person is obviously an intruder, e.g. wearing a mask. The monitoring service provider may ask for an authorization code from the person generating an alarm event, but not all family, friends and close acquaintances would know or remember the code. The monitoring service providers in these situations tend to err on the side of caution and notify the authorities since they are liable in part for the safety and protection of the premise. This has become a serious problem in some regions, and police in some cases have stopped responding to alarm events without having at least video verification from the monitoring service provider, which, as discussed above, is far from accurate.

In some regions it may be a regulated requirement that a central monitoring service provider monitor the premise alarm systems 106.8 f, g, h, i, j, k, l, m and n in order for respective insurance premium discounts to be obtained, or insurance providers may require this before offering respective insurance premium discount. In these situations, and others, the central monitoring service can provide a contact of last resort service. Referring to FIG. 8c, if during an alarm event at the premise 100.8f, none of the family, friends and close acquaintance members of the peer network 101f respond to the notification attempts performed by the premise alarm systems 106.8f, g, h, i, j, k, l, m and n, for example not one of these members answers a VoIP call from respective premise alarm systems after a certain number of ring attempts, then the premise alarm system 106.8f can notify the central monitoring service that the notification attempts of the alarm event have not been responded to by members of the peer network 101f, and therefore the central monitoring service would then respond, i.e. attempt to verify the alarm event as an intrusion and take appropriate action. The central monitoring service is operational twenty four hours per day and staffed with alarm personnel who can respond to the alarm notification from the premise alarm system 106.8f.

In this situation, there will be a monitoring fee paid to the central monitoring service. However, since the central monitoring service is a contact of last resort, then statistically they will be contacted much less frequently than other central monitoring services, which are contacts of first resort, for a given customer base. For example, it is expected that members of the peer network 101f respond statistically more often then not to alarm notification attempts, and therefore the central monitoring service is not notified to take action for most alarm events. The call volume for the central monitoring service operating on the principle of contact of last resort is much less then the call volume for the central monitoring services operating on the principle of contact of first resort. Therefore, the operating costs of the central monitoring service operating on the principle of contact of last resort are much less then the operating costs of central monitoring services operating on the principle of contact of first resort, since the former requires less equipment and staff. The reduced operating costs are passed on to the consumer, i.e. the owner of the premise 101f, and therefore the monitoring fees can be less.

The monitoring fee paid by the owner of the premise 100.8f to the central monitoring service operating on the principle of contact of last resort can be calculated based on the percentage of alarm events that the central monitoring service was notified of to take action by the premise alarm system 106.8f. The principle of the present invention is peer monitoring and therefore less dependence on monitoring service providers. If the monitoring service provider is in actual fact responding to most alarm events for a given premise then that premise should pay higher monitoring fees. It is the responsibility of the members of the peer network 101f to monitor alarm events in the peer network 101f.

In order for the members of the peer network 101f to respond to notification attempts of alarm events in the peer network 101f in ample time before the central monitoring service is notified, the premise alarm systems 106.8f, g, h, i, j, k, l, m and n should know how to reach their respective contacts. This involves, for example, knowing which particular communication device the respective contacts are using and knowing how to contact that device. The respective contacts of the premise alarm systems 106.8f, g, h, i, j, k, l, m and n may periodically notify their respective premise alarm systems with information related to how they can be contacted. The premise alarm systems 106.8f, g, h, i, j, k, l, m and n may also employ smart algorithms that determine how to notify their respective contacts. For example, the algorithms may use location services provided by cellular service providers to determine whether a cellular phone of a contact is changing location, in which case the contact is most likely with the cellular phone and can be notified that way.

Referring again to FIGS. 8a and 8b, the insurance customers associated with the premise alarm systems 106.8a, b, c and d, which are masters of peer networks 101a, b, c and d respectively, are entitled to receive a discount on their respective insurance premiums if they exchange system parameter information with the insurance auditor 104.8. The premise alarm systems 106.8 associated with the peer networks 101a, b, c and d can exchange information with each other, and in particular system parameter information, alarm information and media information, using conventional means of exchanging information over the network 102.8.

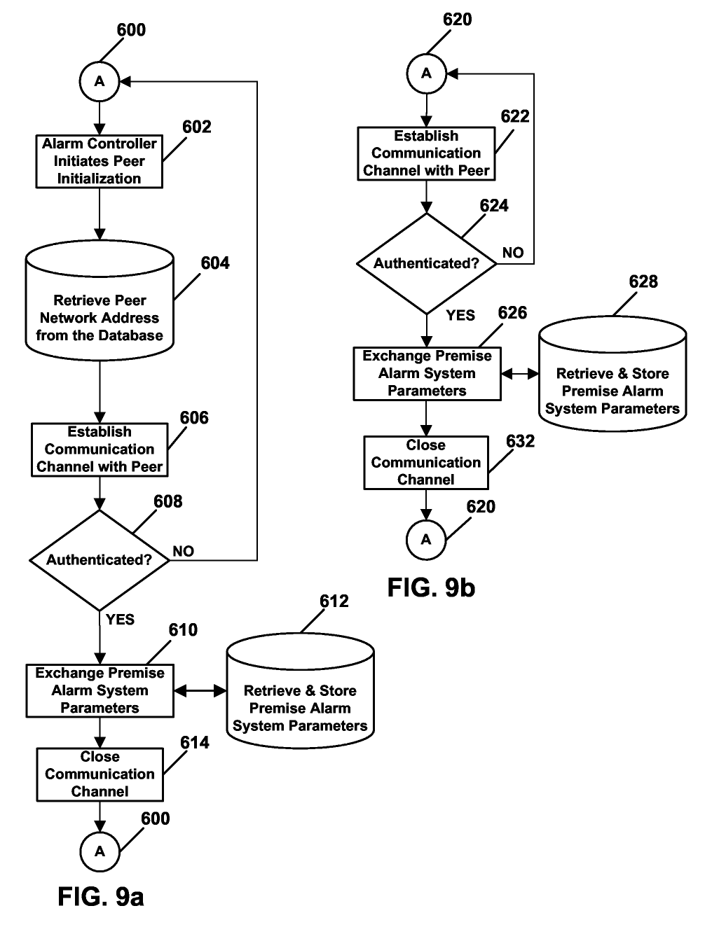

Referring to FIG. 9a, a flowchart diagram is shown illustrating the operation of the alarm controller software of one of the premise alarm systems of FIG. 8a, for example the premise alarm system 106.8a, initiating and performing the process of exchanging system parameter information with another premise alarm system, for example the premise alarm system 106.8b. In one situation, this can be the first time the premise alarm system 106.8a is communicating with the premise alarm system 106.8 in order to invite the premise alarm system 106.8b into the peer network 101a. In another situation, this can be an update of system parameter information between the premise alarm systems 106.8a and 106.8b.

The alarm controller software of the premise alarm system 106.8a is idle in step 600 and in step 602 the alarm controller software initiates peer-to-peer communication with the premise alarm system 106.8b. A human operator can stimulate the transition from step 600 to step 602, for example, if this is the first time the premise alarm systems 106.8a and 106.8b are communicating with each other, or the alarm controller software can stimulate the transition itself by responding to a scheduled software event when performing scheduled peer communications. The alarm controller software performs housekeeping operations and reserves any resources it may require in step 602, before transitioning to step 604.

In step 604 the alarm controller software retrieves the network address of the peer premise alarm system 106.8b. The network address must have been added to the alarm controller database by the insurance customer if this is the first time the alarm controller software is contacting the premise alarm system 106.8b. The network address is used to establish a communication channel with the peer premise alarm system 106.8b in step 606. Again, conventional means are used for establishing the communication channel over the network 102.8.

The alarm controller software can request the peer premise alarm system 106.8b to authenticate itself to ensure that the communication channel is with the intended peer premise alarm system. If authentication fails the alarm controller software can record this event in the alarm controller database, close the communication channel and return to step 600.

The alarm controller software exchanges system parameters with the premise alarm system 106.8b in step 610. The alarm controller software sends a request to the premise alarm system 106.8b for one or more system parameters and, if the premise alarm system 106.8 accepts the request, receives the one or more system parameters which it stores in the alarm controller database in step 612. At this point the premise alarm system 106.8b has joined the peer network 101a as a slave.

The premise alarm system 106.8b may also request one or more system parameters from the alarm controller software in step 610. If the alarm controller software accepts the request, it retrieves the one or more system parameters from the alarm controller database in step 612 and sends them to the premise alarm system 106.8b in step 610. At this point the premise alarm system 106.8a has joined the peer network 101b as a slave. The communication channel is closed in step 614 and the alarm controller software returns to idle in step 600.

Referring now to FIG. 9b, a flowchart diagram is shown illustrating the corresponding operation of the alarm controller software of the premise alarm system 106.8b discussed above in relation to FIG. 9a. The alarm controller software receives a request to establish a communication channel with the peer premise alarm system 106.8a in step 620 and transitions to step 622 where the communication channel is established.

The alarm controller software can request the peer premise alarm system 106.8a to authenticate itself by conventional means of authentication in step 624. In most examples authentication would be performed for security reasons, but it is not essential for operation. In is understood that in other examples steps 622 and 624 can be performed together. If the peer premise alarm system 106.8a can not authenticate itself the alarm controller software stores a record of this event in the alarm controller database, and notifies the insurance customer and returns to step 620. If the peer premise alarm system 106.8a can authenticate itself it proceeds to step 626.

The alarm controller software receives a request for one or more system parameters from the peer premise alarm system 106.8a in step 626. If the alarm controller software accepts the request, it retrieves the one or more system parameters from the alarm controller database in step 628 and sends them to the peer premise alarm system 106.8a in step 626. The premise alarm system 106.8b has joined the peer network 101a at this point as a slave.

The alarm controller software may request one or more system parameters from the peer premise alarm system 106.8 in step 626. If the peer premise alarm system 106.8a accepts the request the alarm controller software receives the one or more system parameters in step 626 and stores them in the alarm controller database in step 628. The premise alarm system 106.8a has joined the peer network 101b at this point as a slave. The communication channel is closed in step 632 before returning to step 620.

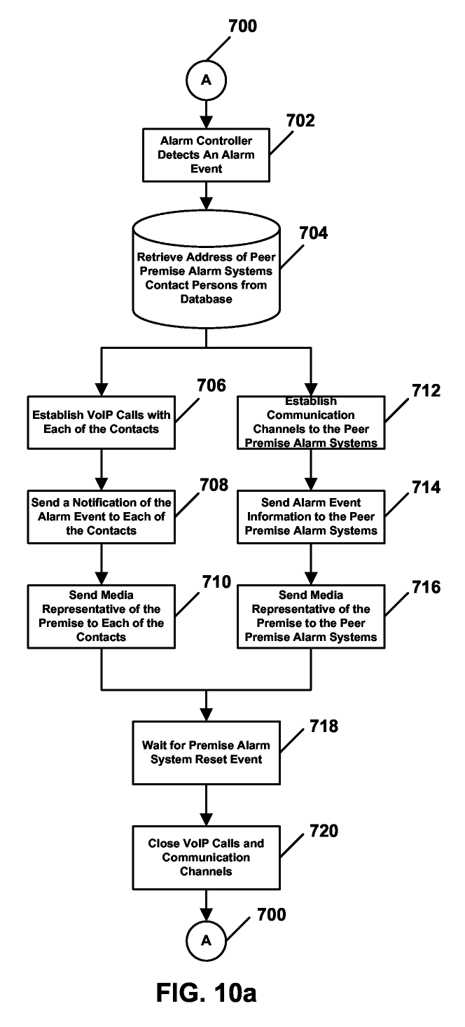

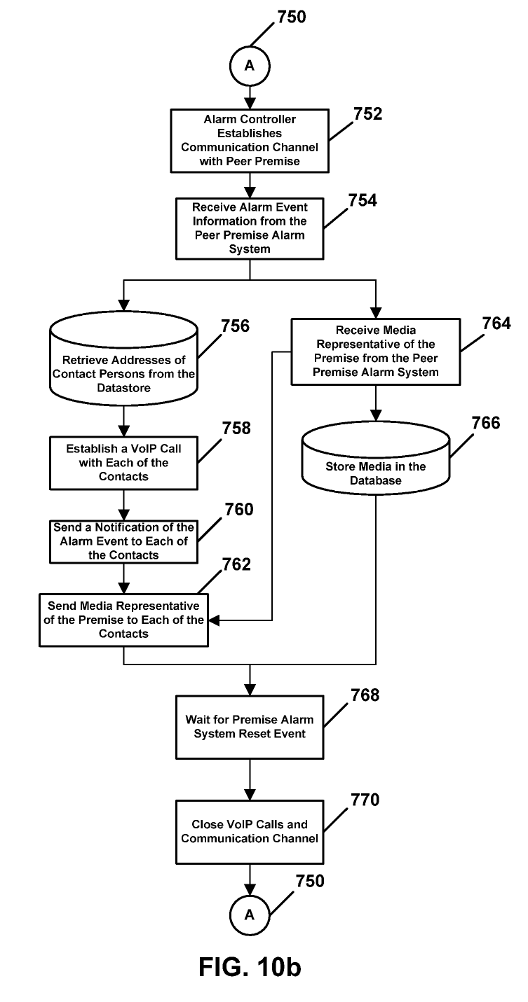

Referring back to FIG. 8a, the premise alarm system 106.8a can communicate alarm event information and media with the premise alarm systems 106.8b and 106.8c of the peer network 101a during an alarm event. Referring now to FIG. 10A, a flow chart diagram is shown illustrating the operation of the alarm controller software of the premise alarm system 106.8a during an alarm event at premise 100.8a.

The alarm controller software is monitoring the sensors 110 in step 700 and transitions to step 702 after detecting an alarm event. The alarm controller software does general housekeeping tasks and reserves any resources in step 702 before proceeding to step 704. The network addresses of the peer premise alarm systems 106.8b and 106.8c and of contact persons of the premise alarm system 106.8a are retrieved from the alarm controller database in step 704.

Two threads of execution are carried out after step 704. In one thread the peer premise alarm systems 106.8b and 106.8c are contacted, and in the other thread the contact persons are contacted.

A Voice/Video over IP (VoIP) call is established over the network 102.8 with each of the contact persons using their respective network addresses in step 706. Once the VoIP calls are made the contact persons are informed there is an alarm event in step 708, and media representative of the premise 100.8a is sent over the VoIP call in step 710.

A secure communication channel is established with each peer premise alarm system 106.8b and 106.8c using conventional means discussed above for establishing a secure communication channel over network 102.8 in step 712. Once the communication channels are opened a notification of the alarm event is sent to the peer premise alarm systems 106.8b and 106.8c in step 714. The alarm controller software then sends media over the communication channels representative of the premise 100.8a to each of the peer premise alarm systems 106.8b and 106.8c in step 716.

It is possible in other examples where the network 102.8 also comprises the Internet that a single multicast communication channel is established to multicast the media. In this situation each of the peer premise alarm systems 106.8b and 106.8c would be part of a multicast group. During an alarm event the peer premise alarm systems 106.8b and 106.8c are notified to join the multicast of the media.

The alarm controller software waits for an alarm reset event in step 718, and when the reset is received the VoIP calls and the communication channels are closed in step 720 and the alarm controller software returns to step 700.

Now referring to FIG. 10b, a flowchart diagram is shown illustrating the corresponding operation of the alarm controller software of each of the peer premise alarm systems 106.8b and 106.8c discussed above in relation to FIG. 10b. The alarm controller software is idle in step 750 and transitions to step 752 after receiving a request from the peer premise alarm system 106.8a to open a communication channel. The alarm controller software opens the communication channel and after authentication, receives a notification of an alarm event in step 754.

Two threads of execution are carried out after step 754. In one thread the contact persons are contacted, and in the other thread media is stored.

The alarm controller software receives the media representative of the premise 100.8a where the alarm event originates in step 764 and the media is saved in step 766.

The alarm controller software retrieves the network addresses of each of the contact persons from the alarm controller database in step 756 and establishes a VoIP call with each of the contact persons using their respective network addresses in step 758. Once the VoIP calls are made a notification is sent over each of the respective call legs to the contact persons in step 760. The media is sent over each of the VoIP call legs in step 762.

The alarm controller software waits for an alarm reset event in step 768, and when the reset is received the VoIP calls and the communication channel are closed in step 770 and the alarm controller software returns to step 750.

In some examples the alarm controller software can be notified by the peer premise alarm system 106.8a over the communication channel to join a multicast group. In this situation, another communication channel is opened to the multicast group and the media is received over that multicast channel.

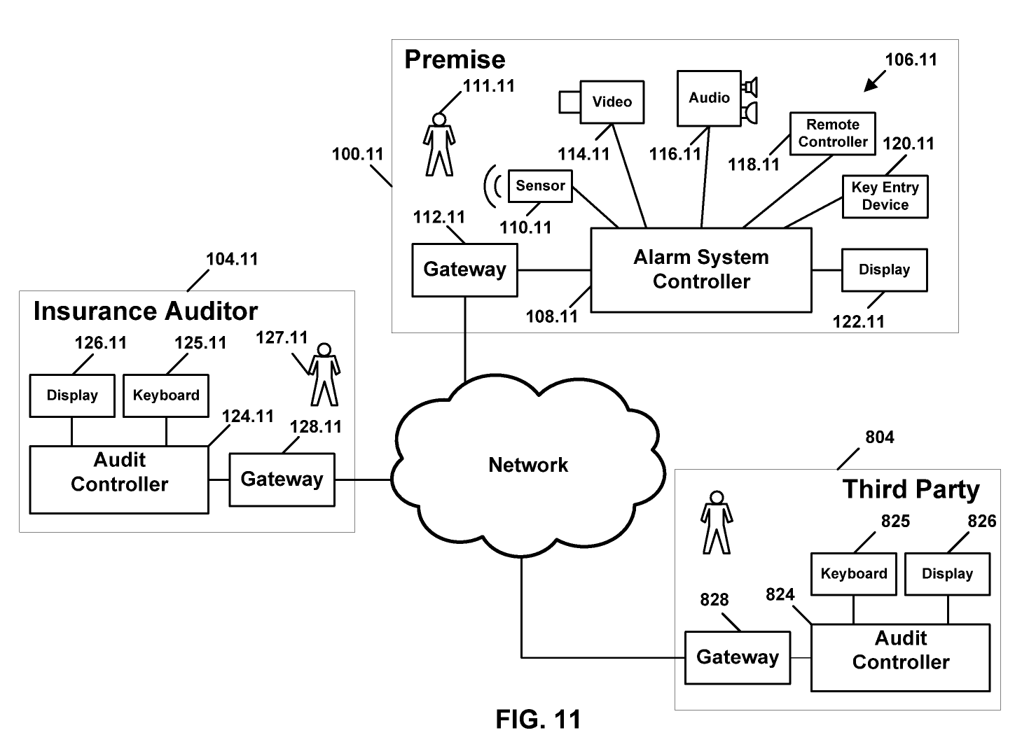

Referring now to FIG. 11, another embodiment of the present invention, wherein like parts to previous embodiments have like reference numerals with an additional suffix “.11”, comprises a premise 100.11 having a premise alarm system 106.11, an insurance auditor 104.11 and a third party 804. The third party 804 can be, for example and without limitation, an insurance broker, an insurance agent or a monitoring service provider. The third party 804 is similar to the insurance auditor 104.11, and comprises an audit controller 824, a gateway 828, a keyboard 825 and a display 826.

The third party 804 communicates with the premise alarm system 106.11 in a manner similar to the description above related to FIGS. 5a, 5b, 7a and 7b for the purpose of collecting audit information related to system parameters of the premise alarm system. The third party may, but is not required to, perform the operation of auditing the insurance policy described above in relation to FIGS. 6a and 6b. The third party 804 communicates the audit information to the insurance auditor 104.11 in a similar manner to that described above.

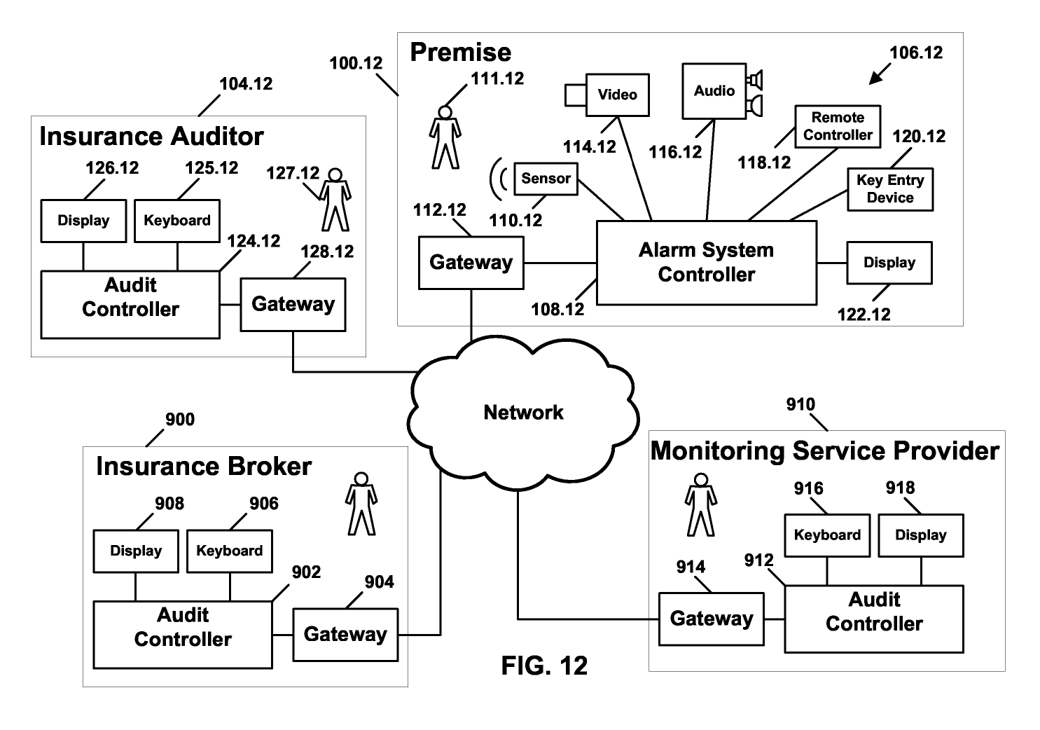

Referring now to FIG. 12, another embodiment of the present invention, wherein like parts to previous embodiments have like reference numerals with an additional suffix “.12”, comprises a premise 100.12 having a premise alarm system 106.12, an insurance auditor 104.12, an insurance broker 900 and a monitoring service provider 910. In this example, the insurance auditor 104.12 is an insurance provider. The insurance broker 900 is similar to the insurance auditor 104.12 and comprises an audit controller 902 and a gateway 904 coupling the audit controller to the network 102.12. The monitoring service provider 910 is similar to the insurance auditor 104.12 and comprises an auditor controller 912 and a gateway 914 coupling the audit controller to the network 102.12.

The monitoring service provider 910 communicates with the premise alarm system 106.12 over network 102.12 to collect audit information related to system parameters of the premise alarm system 106.12. The insurance broker 900 communicates with the monitoring service provider 910 to collect the audit information, and the insurance auditor 104.12 communicates with the insurance broker 900 to collect the audit information from the insurance broker.

Another example of the present invention is now described with reference to FIG. 1. In this example, the premise 100 is a vehicle, the premise alarm system 106 is a vehicle alarm system and the gateway 112 comprises a wireless modem device that provides wireless data service to the network 102. The network 102 is the Internet in this example. The insurance customer can receive a discount on auto insurance if the insurance auditor 104 can audit the vehicle alarm system and obtain system parameters therefrom. The vehicle alarm system can form peer networks as described above for the premise alarm system. The operation of the premise alarm system described above similarly applies to the vehicle alarm system.

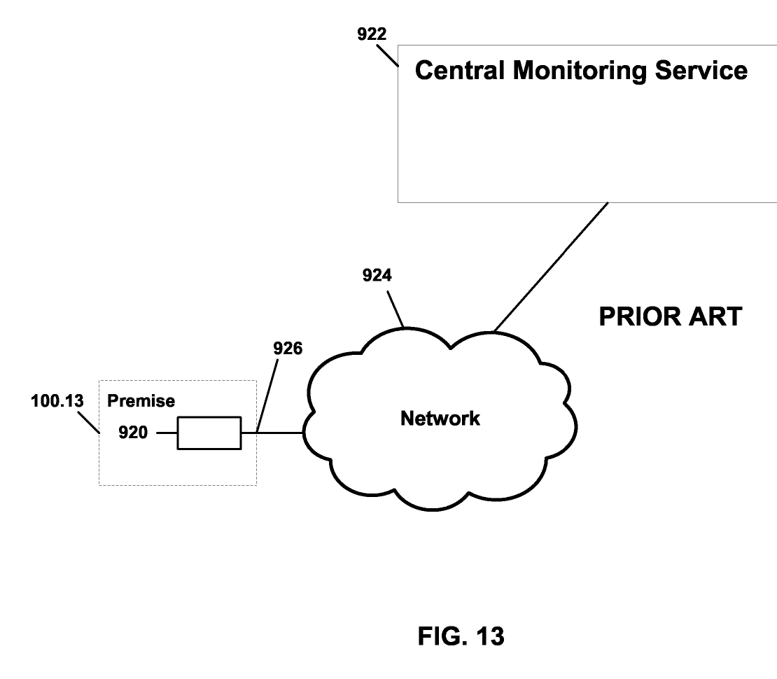

In another example of the present invention, reference is first made to FIG. 13, wherein like parts have like references numerals with an additional suffix “.13”, which shows a simplified network diagram of a conventional premise alarm system 920 that is configured to contact a central monitoring station 922 upon detection of an alarm event. The premise alarm system 920 is installed at premise 100.13, and is connected with network 924 by interface 926. Traditionally, the network 924 comprises the public switched telephone network (PSTN), and the interface 926 is a PSTN interface. The central monitoring station 922 is connected with the network 924.

The premise alarm system 920 calls the central monitoring station 922 by dialing a telephone number when an alarm event is detected at the premise 100.13. The central monitoring station 922 answers the call and thereby establishes a telecommunication call between the premise alarm system 920 and the central monitoring station 922 through network 924. The telecommunication call notifies the central monitoring station 922 of the alarm event at the premise. In some situations the premise alarm system 920 sends a signal to the central monitoring station 922 indicating the status of the premise alarm system 920, for example which zone has generated the alarm event.

Note that in other situations it is sufficient for the premise alarm system 920 to go “off-hook” to notify a central office that an alarm event is taking place at the premise. The central office can take further action to notify the central monitoring station 922, or can act as the central monitoring station itself.

After being notified of the alarm event, the central monitoring station 922 takes steps to confirm the alarm event and/or respond to the alarm event, e.g. calling numbers on an emergency call list, dispatching security personnel to the premise and contacting emergency services such as the police or fire department.

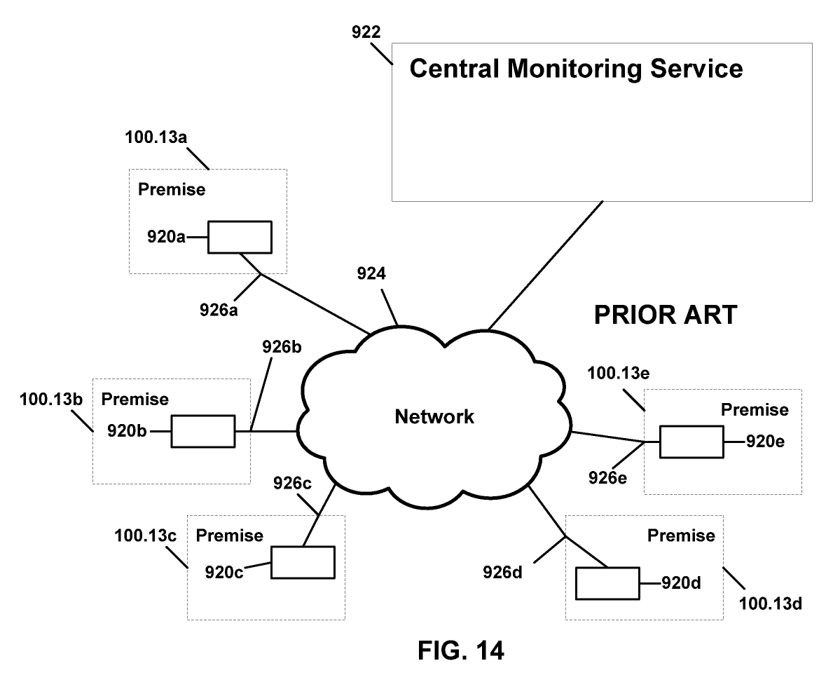

Referring to FIG. 14, a plurality of premise alarm systems 920a,b,c,d and e installed at premises 100.13a,b,c,d and e respectively are configured to contact the central monitoring station 922. Each of these premise alarm systems 920a,b,c,d and e are independent and separate from each other, and the central monitoring station 922 handles them in this way. For example, when setting up the monitoring service the central monitoring station 922 is provided with an emergency call list of telephone numbers that it should call upon detection of a burglary alarm event in order to verify the event. The emergency call list of telephone numbers may include one or more telephone numbers, and the central monitoring station 922 calls these numbers one at a time. The telephone numbers in the emergency call list usually include the telephone number of the premise and, for example, a cellular number of the premise owner.

It would be advantageous for premises with conventional premise alarm systems 920 installed, which typically use the PSTN as a means of contacting the central monitoring station 922, to be able to form security communities in order to receive the benefits of such security communities described earlier.

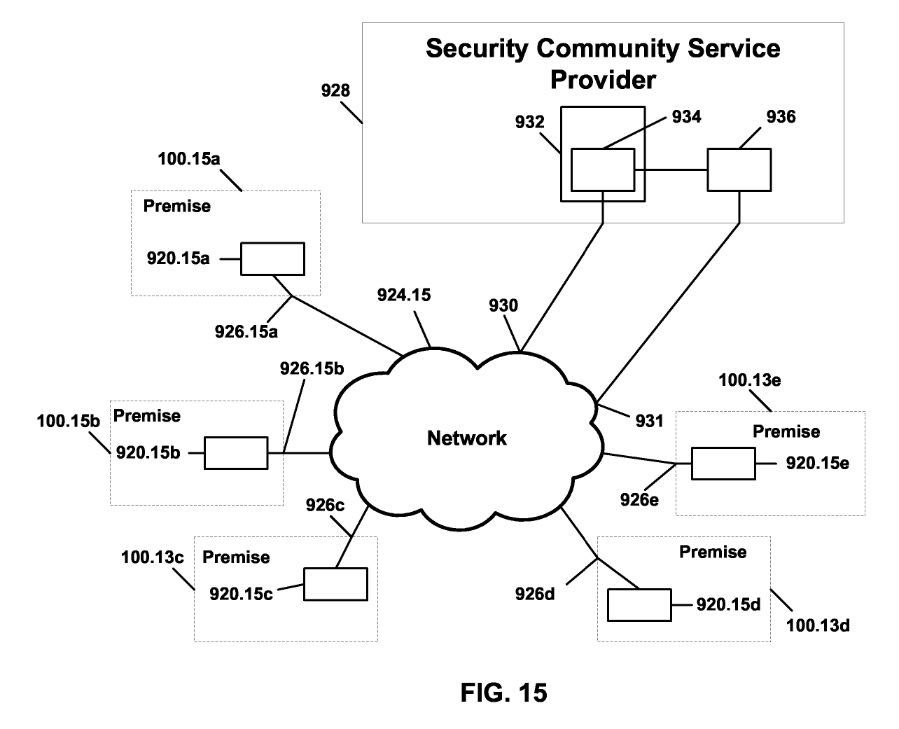

Referring now to FIG. 15, wherein like parts to previous embodiments have like reference numerals with an additional suffix “.15”, there is shown a simplified network diagram of a system that includes a plurality of premise alarm systems 920.15a,b,c,d and a security community service provider 928 connected with a network 924.15. The network 924.15 comprises the PSTN and the Internet in this example, but other types of networks are possible in different examples.

The premise alarm systems 920.15a,b,c,d and e are conventional premise alarm systems installed at premises 100.15a,b,c,d and e respectively, and are connected with the network 924.15 by interfaces 926.15a,b,c,d and e respectively. The interfaces 926.15a,b,c,d and e are PSTN interfaces in this example, but other types of interfaces are possible. Each of the interfaces 926.15a,b,c,d and e have associated therewith a telephone number.

The security community service provider 928 is connected with the network 924.15 by interfaces 930 and 931. In this example, the interface 930 comprises an Internet interface and the interface 931 comprises a PSTN interface. The Internet interface 930 can comprise, but is not limited to, an xDSL modem, a cable modem, a CDMA modem, GPRS modem or a satellite modem. The PSTN interface 931 can comprise, but is not limited to, a plain old telephone service (POTS) interface or a T1, E1, E3 or DS3 interface. In other examples the security community service provider 928 can have a different number and type of interfaces to the network 924.15.

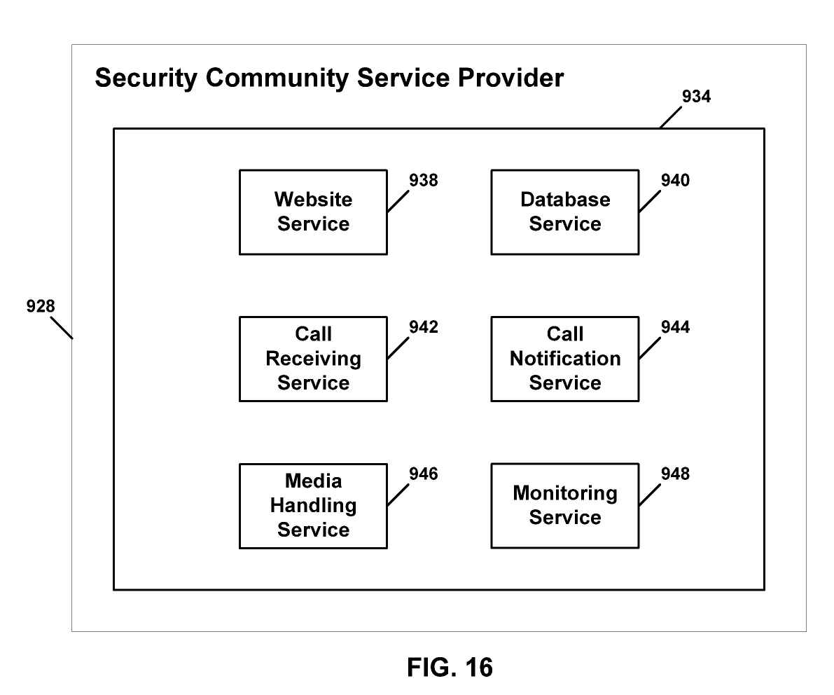

Referring to FIGS. 15 and 16, the security community service provider 928 comprises a server 932, i.e. a personal computer, which runs an application 934. The application 934 provides a number of services that enable the security community service, and these services include, but are not limited to, a website service 938, a database service 940, a call receiving service 942, a call notification service 944, a media handling service 946 and a monitoring service 948. Some of these services have support services which can include conventional software components, for example, a web server. There is also a PSTN bridge 936 which is connected with the PSTN interface 931 and the application 934.

In a simple example, the website service 938 of the application 934 allows a user operating a personal computer connected with the Internet to create a user account. The user is typically a manager of a premise alarm system, for example the premise alarm system 920.15a, and the manager is typically the owner of the premise 100.15a where the premise alarm system 920.15a is installed. The user uses a conventional browser application on a personal computer to access the website service 938 to create a security community that includes information about the premise alarm system 920.15a, for example the telephone number associated with the PSTN interface 926.15a and/or an identification passcode of the premise alarm system 920.15a. The user is referred to as the manager of the security community. The website also allows the manager of the security community and premise alarm system 920.15a to identify the various components of the premise alarm system 920.15a, e.g. control panels, sensors, video cameras, audio devices and media and event recorders.

The manager can invite other people to join the security community, and these people are referred to as members of the security community. The members can be for example family, friends and close acquaintances. The members can be themselves a manager of respective premise alarm systems, but this is not a requirement. Each member also has a user account. Each member in the security community has a member profile that includes information about the member, e.g. user identification of the member's respective user account, authorization and permissions, and contact information such as a telephone number. The members can login to the security community web pages provided by the website service 938, which are accessible only by the members of the security community, and see the status of the premise alarm system 920.15a according to each member's respective permissions. For example, during an alarm event some members in the security community are allowed to hear and/or view audio and/or video data, and other members are not.

The user can create one or more security communities, and each security community can include one or more premise alarm systems. The user can also belong to other security communities in which the user is a member and not a manager. When the user logs into their respective user account, all the security communities in which the user is a manager or a member are identified visually.

The information about the user accounts, security communities, premise alarm systems and member profiles is stored by the database service 940 so that it can be retrieved by any one of the services 938, 940, 942, 944, 946 and 948 of the application 934.

The call receiving service 942 has associated with it one or more phone numbers. The premise alarm systems 920.15a,b,c,d and e are each configured with the one or more phone numbers which are called by the premise alarm systems during an alarm event. The call receiving service 942 accepts alarm event calls coming from the premise alarm systems 920.15a,b,c,d and e, and receives information that identifies the premise alarm system, and in some situations further information about the status of the premise alarm system. In this example, the manager of the security community and the premise alarm system 920.15a programs the premise alarm system 920.15a to call the call receiving service 942 upon the detection of an alarm event. The call receiving service 942 can also accept calls coming from other sources, for example, the manager and members of the security community.

The call receiving service 942 can determine the telephone number of the premise alarm system 920.15a that is calling as it is ringing, e.g. by call display, to identify which premise alarm system is calling. It is possible in some situations for the call receiving service 942 to answer the call and receive further identification information from the premise alarm system 920.15a over the call. In this example the call receiving service 942 is connected with the PSTN by the PSTN bridge 936, and is connected with the Internet (to receive VoIP calls) by the Internet interface 930, and in other examples the call receiving service can be connected with different networks.

The call notification service 944 receives information related to the alarm event from the premise alarm system 920.15a from the call receiving service 942. The call notification service 944 then notifies the manager and each of the members of the security community for the premise alarm system 920.15a about the alarm event. There are a number of ways in which the call notification service 944 can accomplish this, some of which include placing a call (PSTN call, Voice/Video over IP call, page), push-to-talk call, an instant message or an email. The web pages from the website service 938 associated with the security community indicate that an alarm is currently happening. Typically, the notification of the manager and each of the members is performed in parallel.

The media handling service 946 is configured to receive media during an alarm event, e.g. audio and/or video data, from the premise alarm system 920.15a, if such media is available. The media handling service 946 can present audio and/or video information on the web pages of the security community from the website service 938, or can deliver the audio and/or video to the manager and members of the security community through the call notification service 944.

When the manager and the members of the security community do not acknowledge an alarm event from the premise alarm system 920.15a, e.g. by accepting a call from the call notification service 944 and pressing a key to send a DTMF tone to confirm or submitting an acknowledgement through the web pages from website service 938, then the monitoring service 948 (see FIG. 16) is notified by the call notification service 944. The monitoring service 948 then notifies an operator of a 24×7 monitoring service (not shown) by placing a call, e.g. a VoIP call or a PSTN call. The operator after being notified will then take appropriate action, for example, contacting emergency services such as the police. The 24×7 monitoring service can be co-located with the security community service provider 928, or can be located at a different location. In the later case, the 24×7 monitoring service is operatively coupled with the service provider 928 through the network 924.15.

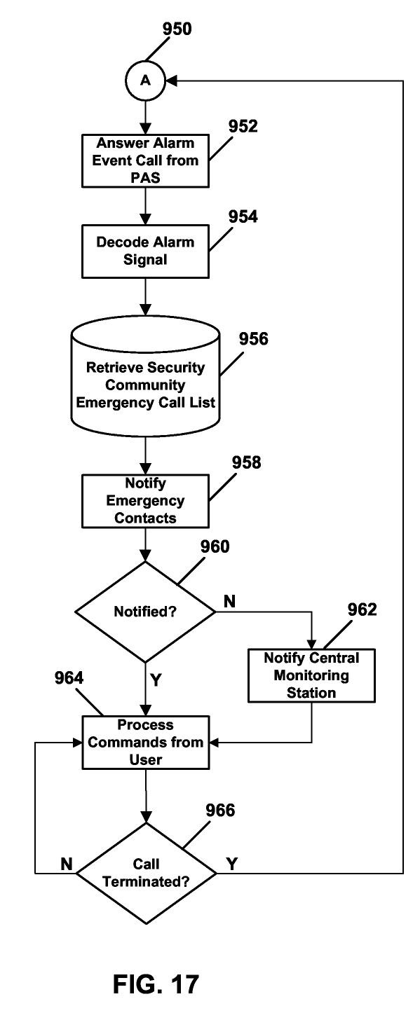

Referring to FIGS. 15, 16 and 17, a description of the stages in an alarm event is now provided. When the premise alarm system 920.15a detects an alarm event it calls the call receiving service 942. The call receiving service 942 accepts the incoming alarm call in step 952 and determines which premise alarm system 920.15a is calling by either the telephone number of the calling party or a signal from the premise alarm system. The call receiving service 944 then receives information about the status of the premise alarm system 920.15a from a signal sent by the premise alarm system, if the signal is available, which is decoded in step 954. The call receiving service 942 then determines which security community is experiencing an alarm event by retrieving this information from the database service 940 in step 956 and notifies the call notification service 944.

The call notification service 944 retrieves the contact information of the manager and the members of the security community and attempts to contact them in step 958 to notify them that the alarm event is taking place. The call notification service 944 can contact the manager and members of the security community in parallel using multiple communication calls, or they can be contacted sequentially by attempting to contact them one at a time, or they can be contacted using a combination of parallel and sequential calls. An indication of the alarm event is also presented on the web pages of the security community provided by the website service 938.

The call notification service 944 waits for the manager or one of the members of the security community to answer respective communication calls in order to confirm that at least one person has been notified of the alarm event in step 960. Typically, when one of the communication calls from the call notification service 944 is answered by the manger or one of the members, the person is requested to press a key on the communication device they are using so that a DTMF tone is sent to the call notification service 944 over the communication call. This confirms that the communication call was answered by a person and not an automated answering service.

Media provided by the premise alarm system 920.15a is also presented on web pages, and delivered to the manager and members of the security community by the call notification service 944 over respective communication calls.

If not one of the communication calls from the call notification service 944 is answered by the manager of one of the members of the security community after a specified amount of time, e.g. one minute, then the call notification service 944 notifies the monitoring service 948 which calls a 24×7 central monitoring station in step 962.

A communication call is now established, either with the manager or one of the members of the security community, or with the central monitoring station, and the call notification service 944 now responds to commands from the user over the communication call in step 964. When the call with the user terminates the application 934 returns to step 960.

The application 934 of the security community service provider 928 can be implemented with a number of technologies, including but not limited to Java, JSP, EJBs, JBOSS, C++, C#, ASP, PHP, HTML, FLASH, ASP, PHP, CGI, ODBC, JDBC, Windows, Linux.

As will be apparent to those skilled in the art, other modifications may be made in the above identified invention within the scope of the appended claims.

What is claimed is:

1. A method for an insurance auditor to derive an insurance premium comprising the steps of:
obtaining system parameters over a network of a premise alarm system of a premise; and
deriving the insurance premium by using the system parameters in a multi-variable function.

2. The method of claim 1, wherein the step of obtaining system parameters comprises the steps:
establishing a communication channel through the network between the insurance auditor and a system parameters provider, the system parameters provider providing the system parameters of the premise alarm system; and
communicating the system parameters of the premise alarm system from the system parameters provider to the insurance auditor over the communication channel.

3. The method of claim 1, wherein the step of deriving includes the step of calculating a discount on the insurance premium from the multi-variable function.

4. The method of claim 1, wherein the step of deriving includes the step of calculating the insurance premium from the multi-variable function.

5. The method of claim 2, wherein the network is the Internet.

6. The method of claim 2, wherein the step of establishing a communication channel includes the step of authenticating the insurance auditor to the system parameters provider.

7. The method of claim 2, wherein the step of establishing a communication channel includes the step of authenticating the system parameters provider to the insurance auditor.

8. The method of claim 2, wherein the communication channel is a secure communication channel.

9. The method of claim 2, wherein the step further includes storing the system parameters in a data storage means.

10. The method of claim 1, wherein the method further includes the step of storing the derived insurance premium.

11. The method of claim 2, wherein the system parameters provider is the premise alarm system of the premise.

12. The method of claim 2, wherein the premise is a vehicle, the premise alarm system is a vehicle alarm system and the system parameters provider is the vehicle alarm system.

13. The method of claim 2, wherein the system parameters provider is a monitoring service provider, the monitoring service provider monitoring the premise alarm system.

14. A method for an insurance auditor to audit an insurance policy comprising the steps:
obtaining system parameters of a premise alarm system of a premise; and
auditing the insurance policy with respect to the system parameters of the premise alarm system.

15. The method of claim 14, wherein the step of auditing includes the step of determining if a new insurance premium needs to be calculated.

16. The method of claim 14, wherein the step of auditing includes determining if the system parameters of the premise alarm system have changed since a previous audit.

17. The method of claim 14, wherein the step of auditing includes classifying the premise into a category of insurance from a group of categories of insurance based on the system parameters of the premise alarm system.

18. In combination, an insurance auditor audit means for auditing an insurance policy, a system parameters provider means for providing system parameters of a premise alarm system of a premise and a network:
the insurance auditor audit means comprising:
a first data processing means;
a first data storage means coupled to the first processing means;
a first gateway coupling the first data processing means to the network;
means for communicating the system parameters from the system parameters provider means over the network; and
means for auditing the insurance policy with respect to the system parameters of the premise alarm system;
the system parameters provider means comprising:
a second data processor means;
a second data storage means coupled to the second data processing means;
a second gateway coupling the second data processing means to the network; and
means for communicating the system parameters to the insurance auditor audit means over the network.

19. The combination of claim 18, wherein the network is the Internet.
